(19) United States
(12) Patent Application Publication
(10) Pub. No.: US 2026/0194361 A1
(43) Pub. Date: Jul. 9, 2026

(54) Generating a Travel Itinerary Via a Machine-Learned Model

(71) Applicant: Google LLC, Mountain View, CA (US)

(72) Inventors: Wei Chen, Belmont, MA (US); Steve Yuan, Wilmington, MA (US)

(21) Appl. No.: 19/015,507

(22) Filed: Jan. 9, 2025

(51) Int. Cl. G01C 21/36; G06Q 50/14

(52) U.S. Cl. CPC G01C 21/3682; G06Q 50/14

(57) ABSTRACT

A computing device for generating a travel itinerary includes one or more memories configured to store instructions and one or more processors configured to execute the instructions to perform operations. The operations include receiving an input from a user relating to a query associated with a travel plan associated with a geographic area; based on the input, implementing one or more machine-learned models to generate a travel itinerary satisfying the query, wherein the one or more machine-learned models are trained to generate travel itineraries based on a plurality of images of maps associated with a plurality of geographic areas; and providing, as an output, the travel itinerary.

### FIELD

The disclosure relates generally to implementing navigation operations, for example, via a navigation application, by employing one or more machine-learned models. For example, the disclosure relates to methods and computing devices for generating a travel itinerary which can include navigation routes between different locations, via one or more machine-learned models which utilize an image of a map that includes a geographic region of interest to the user.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

Some machine-learned models are capable of generating answers to basic distance questions by querying a maps application programming interface. However, existing machine-learned models have problems with more complicated trip planning queries (e.g., for generating a travel itinerary) and may not generate a response which is feasible or which satisfies user expectations or user criteria.

### SUMMARY

Aspects and advantages of embodiments of the disclosure will be set forth in part in the following description, or can be learned from the description, or can be learned through practice of the example embodiments.

In one or more example embodiments, a computing device for generating a travel itinerary is provided. For example, the computing device for generating a travel itinerary includes: one or more memories configured to store instructions; and one or more processors configured to execute the instructions to perform operations, the operations comprising: receiving an input from a user relating to a query associated with a travel plan associated with a geographic area; based on the input, implementing one or more machine-learned models to generate a travel itinerary satisfying the query, wherein the one or more machine-learned models are trained to generate travel itineraries based on a plurality of images of maps associated with a plurality of geographic areas; and providing, as an output, the travel itinerary.

In some implementations, the input comprises a text query that specifies one or more points-of-interest associated with the geographic area, and the plurality of images of maps associated with the plurality of geographic areas include the one or more points-of-interest.

In some implementations, the one or more machine-learned models are trained based on training data including the plurality of images of maps associated with the plurality of geographic areas and by instructing the one or more machine-learned models to respond to training queries associated with training travel plans associated with the plurality of geographic areas by selecting correct answers from among a plurality of answers, the plurality of answers including more than one correct answer and at least one incorrect answer.

In some implementations, the training queries associated with the training travel plans associated with the plurality of geographic areas include questions relating to a time to travel between different points-of-interest depicted in the plurality of images of maps associated with the plurality of geographic areas.

In some implementations, the one or more machine-learned models are trained based on training data including the plurality of images of maps associated with the plurality of geographic areas and by training the one or more machine-learned models to recognize and identify points-of-interest depicted in the plurality of images of maps associated with the plurality of geographic areas.

In some implementations, the one or more machine-learned models are trained to generate a travel itinerary satisfying a training query associated with a training travel plan associated with the plurality of geographic areas, the travel itinerary minimizes a travel time between different points-of-interest forming at least a part of the travel itinerary, and the different points-of-interest are depicted in at least one of the plurality of images of maps associated with the plurality of geographic areas.

In some implementations, wherein the operations further comprise providing, as another input to the one or more machine-learned models, an image of a map including the geographic area, and based on the input from the user relating to the query associated with the travel plan associated with the geographic area and the image of the map including the geographic area, implementing the one or more machine-learned models to generate the travel itinerary satisfying the query.

In some implementations, wherein the operations further comprise: processing, by the one or more machine-learned models, the image of the map including the geographic area to recognize a plurality of map features including one or more points-of-interest, one or more geographic terrain features, or one or more road networks, and based on the input from the user relating to the query associated with the travel plan associated with the geographic area, the image of the map including the geographic area, and the plurality of map features, implementing the one or more machine-learned models to generate the travel itinerary satisfying the query.

In some implementations, the operations further comprise: evaluating the travel itinerary to detect a presence of any feasibility errors, based on results of the evaluating, detecting the presence of at least one feasibility error, implementing the one or more machine-learned models to generate a revised travel itinerary satisfying the query based on the at least one feasibility error, and providing, as a further output, the revised travel itinerary.

In some implementations, evaluating the travel itinerary to detect the presence of any feasibility errors comprises the one or more machine-learned models calling a map application programming interface to determine whether travel between locations forming part of the travel itinerary is possible or takes less than a threshold duration of time.

In some implementations, the one or more machine-learned models include a generative machine-learned model provided at the computing system.

In some implementations, the computing system comprises one or more databases configured to store a plurality of generative machine-learned models respectively associated with a plurality of different geographic areas, and the operations further comprise retrieving, from among the plurality of generative machine-learned models, the generative machine-learned model associated with the geographic area.

In some implementations, the generative machine-learned model has been fine-tuned based on a large parameter generative machine-learned model having a greater number of parameters than the generative machine-learned model.

In one or more example embodiments, a computer-implemented method for generating a travel itinerary is provided. The computer-implemented method comprises receiving an input from a user relating to a query associated with a travel plan associated with a geographic area; based on the input, implementing one or more machine-learned models to generate a travel itinerary satisfying the query, wherein the one or more machine-learned models are trained to generate travel itineraries based on a plurality of images of maps associated with a plurality of geographic areas; and providing, as an output, the travel itinerary.

In some implementations, the input comprises a text query that specifies one or more points-of-interest associated with the geographic area, and the plurality of images of maps associated with the plurality of geographic areas include the one or more points-of-interest.

In some implementations, the one or more machine-learned models are trained based on training data including the plurality of images of maps associated with the plurality of geographic areas and by instructing the one or more machine-learned models to respond to training queries associated with training travel plans associated with the plurality of geographic areas by selecting correct answers from among a plurality of answers, the plurality of answers including more than one correct answer and at least one incorrect answer.

In some implementations, the one or more machine-learned models are trained based on training data including the plurality of images of maps associated with the plurality of geographic areas and by training the one or more machine-learned models to recognize and identify points-of-interest depicted in the plurality of images of maps associated with the plurality of geographic areas.

In some implementations, the method includes providing, as another input to the one or more machine-learned models, an image of a map including the geographic area, and implementing the one or more machine-learned models to generate the travel itinerary satisfying the query is based on the input from the user relating to the query associated with the travel plan associated with the geographic area and the image of the map including the geographic area.

In some implementations, the method includes evaluating the travel itinerary to detect a presence of any feasibility errors; based on results of the evaluating, detecting the presence of at least one feasibility error, implementing the one or more machine-learned models to generate a revised travel itinerary satisfying the query based on the at least one feasibility error; and providing, as a further output, the revised travel itinerary.

In one or more example embodiments, a computer-readable medium (e.g., a non-transitory computer-readable medium) which stores instructions that are executable by one or more processors of a computing system is provided. In some implementations the computer-readable medium stores instructions which may include instructions to cause the one or more processors to perform one or more operations which are associated with any of the methods described herein (e.g., operations of the server computing system and/or operations of the computing device). For example, the operations may include: receiving an input from a user relating to a query associated with a travel plan associated with a geographic area; based on the input, implementing one or more machine-learned models to generate the travel itinerary satisfying the query, wherein the one or more machine-learned models are trained to generate travel itineraries based on a plurality of images of maps associated with a plurality of geographic areas; and providing, as an output, the travel itinerary. The computer-readable medium may store additional instructions to execute other aspects of the server computing system and computing device and corresponding methods of operation, as described herein.

These and other features, aspects, and advantages of various embodiments of the disclosure will become better understood with reference to the following description, drawings, and appended claims. The accompanying drawings, which are incorporated in and constitute a part of this specification, illustrate example embodiments of the disclosure and, together with the description, serve to explain the related principles.

### BRIEF DESCRIPTION OF THE DRAWINGS

Detailed discussion of example embodiments directed to one of ordinary skill in the art is set forth in the specification, which makes reference to the appended drawings, in which:

FIGS. 1A-1B depict example systems according to according to one or more example embodiments of the disclosure;

FIG. 2 illustrates a flow diagram of an example, non-limiting computer-implemented method, according to one or more example embodiments of the disclosure;

FIG. 3 depicts an example block diagram of a computing device, according to one or more example embodiments of the disclosure;

FIGS. 4A-4D illustrate example maps of a travel itinerary application and/or a mapping or navigation application, according to one or more example embodiments of the disclosure;

FIG. 5 illustrates an example block diagram of a system for training one or more machine-learned models for a travel itinerary application, according to one or more example embodiments of the disclosure;

FIG. 6 is a flow chart diagram illustrating an example method for training a machine-learned model according to example implementations of aspects of the disclosure;

FIG. 7 is a block diagram of an example processing flow for using machine-learned model(s) to process input(s) to generate output(s) according to example implementations of aspects of the disclosure;

FIG. 8 is a block diagram of an example sequence processing model according to example implementations of aspects of the disclosure;

FIG. 9 is a block diagram of an example technique for populating an example input sequence for processing by a sequence processing model according to example implementations of aspects of the disclosure;

FIG. 10 is a block diagram of an example model development platform according to example implementations of aspects of the disclosure;

FIG. 11 is a block diagram of an example training workflow for training a machine-learned model according to example implementations of aspects of the disclosure;

FIG. 12 is a block diagram of an inference system for operating one or more machine-learned model(s) to perform inference according to example implementations of aspects of the disclosure;

FIG. 13 is a block diagram of an example networked computing system according to example implementations of aspects of the disclosure;

FIG. 14 is a block diagram of an example computing device according to example implementations of aspects of the disclosure; and

FIG. 15 is a block diagram of an example computing device according to example implementations of aspects of the disclosure.

### DETAILED DESCRIPTION

Reference now will be made to embodiments of the disclosure, one or more examples of which are illustrated in the drawings, wherein like reference characters denote like elements. Each example is provided by way of explanation of the disclosure and is not intended to limit the disclosure. In fact, it will be apparent to those skilled in the art that various modifications and variations can be made to disclosure without departing from the scope or spirit of the disclosure. For instance, features illustrated or described as part of one embodiment can be used with another embodiment to yield a still further embodiment. Thus, it is intended that the disclosure covers such modifications and variations as come within the scope of the appended claims and their equivalents.

Some machine-learned models are capable of generating answers to basic distance questions by querying a maps application programming interface. However, existing machine-learned models have problems with more complicated trip planning queries (e.g., for generating a travel itinerary) and may not generate a response which is feasible or which satisfies user expectations or user criteria.

According to examples of the disclosure, the methods and computing devices described herein implement one or more machine-learned models which are trained to output a travel itinerary (travel plan) which is feasible, efficient, and meets user expectations. In some implementations, the one or more machine-learned models are trained to output the travel itinerary based on images of maps, for example, images of maps of regions of interest to the user (e.g., images of maps relevant to a query from a user). Training the one or more machine-learned models with images of maps enhances the spatial reasoning capability of the one or more machine-learned models relating to location and distance signals. Training data for the one or more machine-learned models can include images of maps which can include points-of-interest (POIs) such as cities, tourist attractions, hotels, restaurants, etc.), a road network, and prominent geographical features including rivers, lakes, oceans, mountains, canyons, etc. Training data for the one or more machine-learned models can also include questions regarding travelling from a first point to a second point by various methods (e.g., walking, biking, airplane, driving, train, etc.). In some implementations, the one or more machine-learned models described herein can assess or measure a cost-benefit metric based on geolocation information (e.g., a tradeoff between a travel visit and the value of the visit such as the time or distance needed to travel to the destination compared to a great view afforded by the location).

In some implementations, the training data for the one or more machine-learned models can also include option information that can be used to assess the performance of the one or more machine-learned models. For example, the option information can include various ranges of potential answers (e.g., 1-2 hours, 5-10 hours, 5-6 hours, 20-30 minutes, etc.). When providing a response to a query for training, the one or more machine-learned models may be configured to select all options which are correct and incorrect answers can be penalized at different gradations according to an accuracy of the prediction. For example, the one or more machine-learned models may receive a greater penalty for a travel time prediction of 50 hours compared to a prediction of 5 hours, if the actual travel time is 4 hours. As another example, if the correct travel time is four hours, the training example can include a plurality of options from which the one or more machine-learned models can select from (e.g., a) 1-5 hours; b) 6-10 hours; c) 1-2 hours; d) 3-5 hours; e) 3 hours; f) 4 hours; g) 5 hours). If the one or more machine-learned models predicts the travel time is three hours, the one or more machine-learned models can select options a, d, and e while the correct answer is a, d, and f. Because the answer is partially correct, the one or more machine-learned models will receive partial credit when assessing performance (e.g., a greater amount of credit compared to an answer which has no correct answers or fewer correct answers).

One or more technical benefits of the disclosure include generating a customized travel itinerary based on an input query regarding a trip plan associated with a geographic area, by implementing one or more machine-learned models (e.g., generative machine-learned models) which process an image of a map and the content of the query to output a travel itinerary. For example, the generative machine-learned model may be trained to generate travel itineraries based on training data including images of maps which include a plurality of geographic areas. Compared to existing generative machine-learned models, the generative machine-learned models described herein may generate travel itineraries which are feasible, more efficient, and satisfy user expectations, specifications, and preferences. For example, travel time can be reduced compared to the time for travel with respect to travel itineraries output by existing methods. Therefore, there is a technical improvement compared to existing methods in that feasible and efficient trip plans or travel itineraries are output, reducing the need for users to request the generative machine-learned model to regenerate a travel itinerary which is impractical or inefficient or nonsensical. This results in computing resources being efficiently utilized or conserved (e.g., reduced network traffic, less processing power being expended for additional inferences, etc.). Furthermore, other resources related to conducting a trip and performing navigation are conserved and/or efficiently utilized. For example, carrying out the travel itinerary output by the machine-learned models described herein can result in less energy consumption (e.g., lower fuel costs, conservation of battery power, etc.), time savings, and less wear and tear on vehicles used for travelling.

Another technical benefit of the disclosure includes providing fine-tuned or distilled generative machine-learned models for generating a travel itinerary. The fine-tuned or distilled generative machine-learned models can have improved speed and reduced size (thereby saving storage space) compared to existing models and can be deployed on a user computing device more easily. For example, fine-tuned or distilled generative machine-learned models may be utilized for particular geographic areas rather than a larger model which is implemented for all geographic areas or for a large number of geographic areas.

Another technical benefit of the disclosure includes embodiments in which the generative machine-learned models are trained using a question and answer bank in which the generative machine-learned models are configured to select correct answers from a plurality of possible answers (e.g., in a multiple-choice format) so that the generative machine-learned models can be evaluated with a granularity structure to improve the performance of the generative machine-learned models.

The machine-learned models described herein can conserve computing resources including processing power, memory, network resources (e.g., bandwidth), etc., by providing an output that meets user expectations and that is accurate (e.g., accurately determines a travel itinerary that is feasible and efficient, that satisfies conditions input to the model, etc.). This reduces the need for additional requests by the user, and saves time and computing resources by not requiring the user to input additional prompts or edit existing prompts and thus avoids the need for processing prompts and generating further inferences. Further, in some implementations the machine-learned models described herein can be embodied by pre-existing machine-learned models that are capable of processing prompts as described herein to generate the final image output. For example, enabling the reuse of a pre-existing machine-learned model with the new techniques described herein, can save or conserve storage on a computing device and/or time for training because it is not necessary to train and store a new model.

Therefore, aspects of the disclosure provide technical effects, benefits, and/or improvements in computing technology and the technology of content generation systems and machine-learned models relating to the technical fields of generating travel itineraries and map and navigation systems, via one or more computing devices (e.g., a user computing device, a server computing system, and combinations thereof) which implement machine-learned models, as described herein.

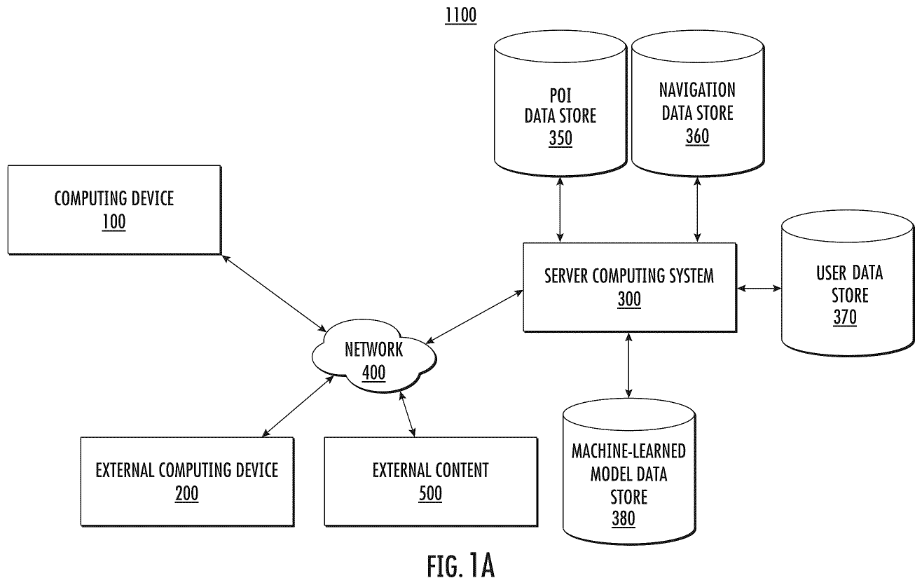

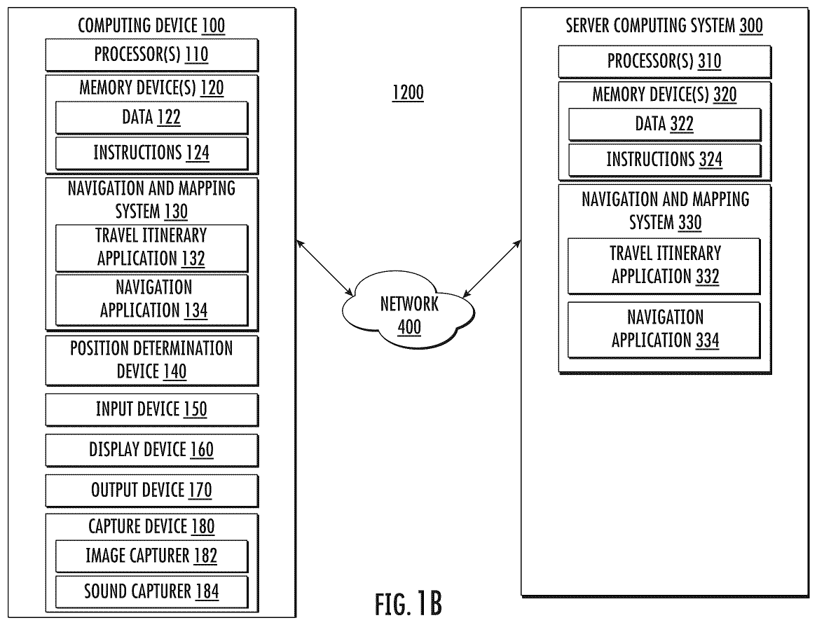

Referring now to the drawings, FIG. 1A is an example system according to one or more example embodiments of the disclosure. FIG. 1A illustrates an example of a system 1100 which includes a computing device 100, an external computing device 200, a server computing system 300, and external content 500, which may be in communication with one another over a network 400. For example, the computing device 100 and the external computing device 200 can include any of a personal computer, a smartphone, a tablet computer, a global positioning service device, a smartwatch, and the like. The network 400 may include any type of communications network including a wired or wireless network, or a combination thereof. The network 400 may include a local area network (LAN), wireless local area network (WLAN), wide area network (WAN), personal area network (PAN), virtual private network (VPN), or the like. For example, wireless communication between elements of the example embodiments may be performed via a wireless LAN, Wi-Fi, Bluetooth, ZigBee, Wi-Fi direct (WFD), ultra wideband (UWB), infrared data association (IrDA), Bluetooth low energy (BLE), near field communication (NFC), a radio frequency (RF) signal, and the like. For example, wired communication between elements of the example embodiments may be performed via a pair cable, a coaxial cable, an optical fiber cable, an Ethernet cable, and the like. Communication over the network 400 can use a wide variety of communication protocols (e.g., TCP/IP, HTTP, SMTP, FTP), encodings or formats (e.g., HTML, XML), and/or protection schemes (e.g., VPN, secure HTTP, SSL).

As will be explained in more detail below, in some implementations the computing device 100 and/or server computing system 300 may form part of a travel planning system and/or a navigation and mapping system which can provide a customized travel itinerary for a user of the computing device 100 via one or more machine-learned models.

In some example embodiments, the server computing system 300 may obtain data from one or more of a POI data store 350, a navigation data store 360, a user data store 370, and a machine-learned model data store 380, to implement various operations and aspects of the navigation and mapping system as disclosed herein. The POI data store 350, navigation data store 360, user data store 370, and machine-learned model data store 380 may be integrally provided with the server computing system 300 (e.g., as part of the one or more memory devices 320 of the server computing system 300) or may be separately (e.g., remotely) provided. Further, POI data store 350, navigation data store 360, user data store 370, and machine-learned model data store 380 can be combined as a single data store (database) or may include a plurality of respective data stores. Data stored in one data store (e.g., the POI data store 350) may overlap with some data stored in another data store (e.g., the navigation data store 360). In some implementations, one data store (e.g., the machine-learned model data store 380) may reference data that is stored in another data store (e.g., the user data store 370).

POI data store 350 can store information about locations or points-of-interest, for example, for points-of-interest in an area or region associated with one or more geographic areas. A point-of-interest may include any destination or place. For example, a point-of-interest may include a restaurant, museum, sporting venue, concert hall, amusement park, school, place of business, grocery store, gas station, theater, shopping mall, lodging, and the like. Point-of-interest data which is stored in the POI data store 350 may include any information which is associated with the POI. For example, the POI data store 350 may include location information for the POI, hours of operation for the POI, a phone number for the POI, reviews concerning the POI, financial information associated with the POI (e.g., the average cost for a service provided and/or goods sold at the POI such as a meal, a ticket, a room, etc.), environmental information concerning the POI (e.g., a noise level, an ambiance description, a traffic level, etc., which may be provided or available in real-time by various sensors located at the POI), a description of the types of services provided and/or goods sold, languages spoken at the POI, a URL for the POI, image content associated with the POI, etc. For example, information about the POI may be obtainable from external content 500 (e.g., from webpages associated with the POI or from sensors disposed at the POI).

Navigation data store 360 may store or provide map data/geospatial data to be used by server computing system 300. Example geospatial data includes geographic imagery (e.g., digital maps, satellite images, aerial photographs, street-level photographs, synthetic models, etc.), tables, vector data (e.g., vector representations of roads, parcels, buildings, etc.), point of interest data, or other suitable geospatial data associated with one or more geographic areas. In some examples, the map data can include a series of sub-maps, each sub-map including data for a geographic area including objects (e.g., buildings or other static features), paths of travel (e.g., roads, highways, public transportation lines, walking paths, and so on), and other features of interest. Navigation data store 360 can be used by server computing system 300 to provide navigational directions, perform point of interest searches, provide point of interest location or categorization data, determine distances, routes, or travel times between locations, or any other suitable use or task required or beneficial for performing operations of the example embodiments as disclosed herein.

In some examples, the user data store 370 can include a current user position and heading data. In some examples, the user data store 370 can include information regarding one or more user profiles, including a variety of user data such as user preference data, user demographic data, user calendar data, user social network data, user historical travel data, and the like. For example, the user data store 370 can include, but is not limited to, email data including textual content, images, email-associated calendar information, or contact information; social media data including comments, reviews, check-ins, likes, invitations, contacts, or reservations; calendar application data including dates, times, events, description, or other content; virtual wallet data including purchases, electronic tickets, coupons, or deals; scheduling data; location data; SMS data; or other suitable data associated with a user account. According to one or more examples of the disclosure, the data can be analyzed to determine preferences of the user with respect to a POI, for example, to automatically suggest or automatically provide customized features with respect to representing a location or representing attributes that are preferred by the user (e.g., displaying and/or selecting a POI for a travel itinerary that satisfies preferences of the user, that is compatible with the user, etc.), where a generative machine-learned model is implemented to generate the customized travel itinerary with the displayed and/or selected location. The data can be analyzed to determine preferences of the user with respect to a POI, for example, to determine preferences of the user with respect to traveling (e.g., a mode of transportation, an allowable time for traveling, etc.), to determine possible recommendations for POIs for the user, to determine possible travel routes and modes of transportation for the user to a POI, to determine an appropriate travel itinerary, and the like.

The user data store 370 is provided to illustrate potential data that could be analyzed, in some embodiments, by the server computing system 300 to identify user preferences, to recommend POIs, to determine possible travel routes to a POI, to determine modes of transportation to be used to travel to a POI, to determine videos of locations to provide to a computing device associated with the user, to generate customized travel itineraries, etc. However, such user data may not be collected, used, or analyzed unless the user has consented after being informed of what data is collected and how such data is used. Further, in some embodiments, the user can be provided with a tool (e.g., in a navigation application or via a user account) to revoke or modify the scope of permissions. In addition, certain information or data can be treated in one or more ways before it is stored or used, so that personally identifiable information is removed or stored in an encrypted fashion. Thus, particular user information stored in the user data store 370 may or may not be accessible to the server computing system 300 based on permissions given by the user, or such data may not be stored in the user data store 370 at all.

Machine-learned model data store 380 can store machine-learned models which can be retrieved and implemented by the server computing system 300 for generating distilled or fine-tuned machine-learned models (e.g., distilled or fine-tuned generative machine-learned models) that can be provided to the computing device 100. Machine-learned model data store 380 can also store distilled or fine-tuned machine-learned models (e.g., distilled or fine-tuned generative machine-learned models) which can be retrieved and implemented by the computing device 100. In some implementations, the computing device 100 can retrieve and implement machine-learned models which are large parameter models that have not been fine-tuned or distilled. The machine-learned models (including large parameter models and distilled or fine-tuned models) stored at the machine-learned model data store 380 can include a plurality of generative machine-learned models respectively associated with a plurality of different locations. In some implementations, the machine-learned models include a plurality of generative machine-learned models respectively associated with particular objects or structures which are provided at the plurality of different locations. The machine-learned models may include large language models. The machine-learned models may include generative artificial intelligence (AI) models (e.g., Gemini) which may implement generative adversarial networks (GANs), transformers, variational autoencoders (VAEs), neural radiance fields (NeRFs), and the like. The NeRFs may be trained to learn a continuous volumetric scene function, that can assign a color and volume density to any voxel in the space. The NeRF network's weights may be optimized to encode the representation of the scene so that the model can render novel views seen from any point in space.

External content 500 can be any form of external content including news articles, webpages, video files, audio files, written descriptions, ratings, game content, social media content, photographs, commercial offers, transportation method, weather conditions, sensor data obtained by various sensors, or other suitable external content. The computing device 100, external computing device 200, and server computing system 300 can access external content 500 over network 400. External content 500 can be searched by computing device 100, external computing device 200, and server computing system 300 according to known searching methods and search results can be ranked according to relevance, popularity, or other suitable attributes, including location-specific filtering or promotion.

Referring now to FIG. 1B, example block diagrams of a computing device and server computing system provided in a computing system 1200 are illustrated, according to one or more example embodiments of the disclosure. Although computing device 100 is represented in FIG. 1B, features of the computing device 100 described herein are also applicable to the external computing device 200.

The computing device 100 may include one or more processors 110, one or more memory devices 120, a navigation and mapping system 130, a position determination device 140, an input device 150, a display device 160, an output device 170, and a capture device 180. The server computing system 300 may include one or more processors 310, one or more memory devices 320, and a navigation and mapping system 330.

For example, the one or more processors 110, 310 can be any suitable processing device that can be included in a computing device 100 or server computing system 300. For example, the one or more processors 110, 310 may include one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The one or more processors 110, 310 can be a single processor or a plurality of processors that are operatively connected, for example in parallel.

The one or more memory devices 120, 320 can include one or more non-transitory computer-readable storage mediums, including a Read Only Memory (ROM), Programmable Read Only Memory (PROM), Erasable Programmable Read Only Memory (EPROM), and flash memory, a USB drive, a volatile memory device including a Random Access Memory (RAM), a hard disk, floppy disks, a blue-ray disk, or optical media such as CD ROM discs and DVDs, and combinations thereof. However, examples of the one or more memory devices 120, 320 are not limited to the above description, and the one or more memory devices 120, 320 may be realized by other various devices and structures as would be understood by those skilled in the art.

For example, the one or more memory devices 120 can store instructions, that when executed, cause the one or more processors 110 to execute a travel itinerary application 132, and to execute the instructions to perform operations including: receiving an input from a user relating to a query associated with a travel plan associated with a geographic area; based on the input, implementing one or more machine-learned models to generate a travel itinerary satisfying the query, wherein the one or more machine-learned models are trained to generate travel itineraries based on one or more images of maps associated with the geographic area; and providing, as an output, the travel itinerary, as described according to examples of the disclosure.

One or more memory devices 320 can also include data 322 and instructions 324 that can be retrieved, manipulated, created, or stored by the one or more processors 310. In some example embodiments, such data can be accessed and used as input to implement travel itinerary application 332, and to execute the instructions to perform operations including: receiving an input from a user relating to a query associated with a travel plan associated with a geographic area; based on the input, implementing one or more machine-learned models to generate a travel itinerary satisfying the query, wherein the one or more machine-learned models are trained to generate travel itineraries based on one or more images of maps associated with the geographic area; and providing, as an output, the travel itinerary, as described according to examples of the disclosure.

In some example embodiments, the computing device 100 includes a navigation and mapping system 130. For example, the navigation and mapping system 130 may include the travel itinerary application 132 and a navigation application 134.

According to examples of the disclosure, the travel itinerary application 132 may be executed by the computing device 100 to provide a user of the computing device 100 a way to generate a travel itinerary or trip plan with respect to one or more geographic areas, based on an input from a user by implementing one or more machine-learned models which are trained to output travel itineraries according to training data that includes images of maps that at least partially include the one or more geographic areas. The travel itinerary application 132 may be part of navigation application 134 or a separate mapping application, or may be a standalone application (e.g., a travel application). The travel itinerary application 132 may be configured to be dynamically interactive according to various user inputs. For example, the travel itinerary application 132 may be configured to generate, modify, or customize a travel itinerary based on a user input or query by implementing one more generative machine-learned models (e.g., a voice input which requests that a travel itinerary be modified or updated). The travel itinerary application 132 may be configured to dynamically generate the customized travel itinerary relating to the location (e.g., in real-time) according to the user input. Further aspects of the travel itinerary application 132 will be described herein.

In some examples, one or more aspects of the travel itinerary application 132 may be implemented by the travel itinerary application 332 of the server computing system 300 which may be remotely located, to generate and/or provide a customized travel itinerary in response to receiving an input from a user. In some examples, one or more aspects of the travel itinerary application 332 may be implemented by the travel itinerary application 132 of the computing device 100, to generate and/or provide a customized travel itinerary in response to or based on receiving an input from a user.

According to examples of the disclosure, the navigation application 134 may be executed by the computing device 100 to provide a user of the computing device 100 a way (route) to navigate to one or more locations. The navigation application 134 can provide navigation services to a user. In some examples, the navigation application 134 can facilitate a user's access to a server computing system 300 that provides navigation services. In some example embodiments, the navigation services include providing directions to a specific location such as a POI. For example, a user can input a destination location (e.g., an address or a name of a POI or a category of a POI). In response, the navigation application 134 can, using locally stored map data for a specific geographic area and/or map data provided via the server computing system 300, provide navigation information allowing the user to navigate to the destination location. For example, the navigation information can include turn-by-turn directions from a current location (or a provided origin point or departure location) to the destination location. For example, the navigation information can include a travel time (e.g., estimated or predicted travel time) from a current location (or a provided origin point or departure location) to the destination location.

The navigation application 134 can provide, via a display device 160 of the computing device 100, a visual depiction of a geographic area. The visual depiction of the geographic area may include one or more streets, one or more points of interest (including buildings, landmarks, and so on), and a highlighted depiction of a planned route. In some examples, the navigation application 134 can also provide location-based search options to identify one or more searchable points of interest within a given geographic area. In some examples, the navigation application 134 can include a local copy of the relevant map data. In other examples, the navigation application 134 may access information at server computing system 300 which may be remotely located, to provide the requested navigation services.

In some examples, the navigation application 134 can be a dedicated application specifically designed to provide navigation services. In other examples, the navigation application 134 can be a general application (e.g., a web browser) and can provide access to a variety of different services including a navigation service via the network 400.

For example, the navigation and mapping system 130 may store travel itineraries which were previously generated using one or more machine-learned models (e.g., generative machine-learned models) in the one or more memory devices 120 (e.g., in cache). The travel itineraries may be categorized or classified according to a location, a context in which the travel itineraries were generated (e.g., according to geographic areas associated with the travel itinerary, according to POIs associated with the travel itinerary, according to an activity associated with the travel itinerary, a time of day, a time of year, methods of transportation, etc.). For example, navigation data store 360 may be configured to store travel itineraries which are generated using one or machine-learned models stored at machine-learned model data store 380. An example travel itinerary can include a plurality of destinations that a user is to visit during a period of time (e.g., a single day, a few days, a week, etc.). The travel itinerary can include information relating to a time needed for travel, a time needed to visit certain POIs, methods of transportation, lodging accommodations, dining establishments, etc. In some implementations, the computing device 100 may be configured to retrieve the travel itinerary from the navigation data store 360 (or from a local memory) when the travel itinerary matches or corresponds to a query or input from a user requesting a travel itinerary.

For example, the navigation and mapping system 130 may store images of maps associated with geographic areas which can be utilized by one or more machine-learned models to generate a travel itinerary. For example, navigation data store 360 may be configured to store the images of the maps associated with the geographic areas.

In some implementations, navigation and mapping system 130 (e.g., travel itinerary application 132) may be configured to utilize sensor data obtained by one or more sensors (e.g., at the computing device 100 or elsewhere) to generate a travel itinerary. For example, the sensor data can indicate a state of a location (e.g., a traffic state, weather conditions, the business of a POI, etc.). For example, sensor data obtained by one or more sensors (e.g., at the computing device 100 or elsewhere) may indicate how many people are present at a location (e.g., based on the number of smartphones or other computing devices detected at the location). For example, navigation and mapping system 130 (e.g., travel itinerary application 132) may generate graphical representations of the location according to the number of people, to accurately represent the location and depict a state of the location. For example, the navigation and mapping system 130 (e.g., travel itinerary application 132) may be configured to generate graphical representations of locations forming a travel itinerary using one or more machine-learned models (e.g., generative machine-learned models), in response to a user input that causes a travel itinerary to be generated which includes graphical representations indicating a state of each of the locations. For example, a graphical representation of a location may include an icon or graphical object which is shaded in a manner which represents or indicates the state of the location (e.g., a darker shade indicating a busy or crowded location and a lighter shade indicating a less busy or less crowded location).

In some example embodiments, the computing device 100 includes a position determination device 140. Position determination device 140 can determine a current geographic location of the computing device 100 and communicate such geographic location to server computing system 300 over network 400. The position determination device 140 can be any device or circuitry for analyzing the position of the computing device 100. For example, the position determination device 140 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining a position of the computing device 100.

The computing device 100 may include an input device 150 configured to receive an input from a user and may include, for example, one or more of a keyboard (e.g., a physical keyboard, virtual keyboard, etc.), a mouse, a joystick, a button, a switch, an electronic pen or stylus, a gesture recognition sensor (e.g., to recognize gestures of a user including movements of a body part), an input sound device or speech recognition sensor (e.g., a microphone to receive a voice input such as a voice command or a voice query), a track ball, a remote controller, a portable (e.g., a cellular or smart) phone, a tablet PC, a pedal or footswitch, a virtual-reality device, and so on. The input device 150 may further include a haptic device to provide haptic feedback to a user. The input device 150 may also be embodied by a touch-sensitive display having a touchscreen capability, for example. For example, the input device 150 may be configured to receive an input from a user associated with the input device 150 for generating a travel itinerary.

The computing device 100 may include a display device 160 which displays information viewable by the user (e.g., a map, an immersive video of a location, a user interface screen, etc.). For example, the display device 160 may be a non-touch sensitive display or a touch-sensitive display. The display device 160 may include a liquid crystal display (LCD), a light emitting diode (LED) display, an organic light emitting diode (OLED) display, active matrix organic light emitting diode (AMOLED), flexible display, 3D display, a plasma display panel (PDP), a cathode ray tube (CRT) display, and the like, for example. However, the disclosure is not limited to these example displays and may include other types of displays. The display device 160 can be used by the navigation and mapping system 130 provided at the computing device 100 to display information to a user relating to an input (e.g., information relating to a travel itinerary, a location of interest to the user, a user interface screen having user interface elements which are selectable by the user, etc.). Navigational information can include, but is not limited to, one or more of a digital map of a geographic area (e.g., an overhead view of the geographic area, a perspective or street-view of the geographic area, etc.), the position of the computing device 100 in the geographic area, a route through the geographic area designated on the map, one or more navigational directions (e.g., turn-by-turn directions through the geographic area), travel time for the route through the geographic area (e.g., from the position of the computing device 100 to a POI), and one or more points-of-interest within the geographic area.

The computing device 100 may include an output device 170 to provide an output to the user and may include, for example, one or more of an audio device (e.g., one or more speakers), a haptic device to provide haptic feedback to a user (e.g., a vibration device), a light source (e.g., one or more light sources such as LEDs which provide visual feedback to a user), a thermal feedback system, and the like. According to various examples of the disclosure, the output device 170 may include a speaker which outputs sound which is associated with a travel itinerary based on a user inputting a query or input relating to a trip request that is provided as an input to a generative machine-learned model which generates the customized travel itinerary.

The computing device 100 may include a capture device 180 that is capable of capturing media content, according to various examples of the disclosure. For example, the capture device 180 can include an image capturer 182 (e.g., a camera) which is configured to capture images (e.g., photos, video, and the like) of a location. For example, the capture device 180 can include a sound capturer 184 (e.g., a microphone) which is configured to capture sound or audio (e.g., an audio recording) of a location. The media content captured by the capture device 180 may be transmitted to one or more of the server computing system 300, POI data store 350, navigation data store 360, user data store 370, and machine-learned model data store 380, for example, via network 400. For example, in some implementations imagery may be used to generate a travel itinerary and in some implementations the media content can be provided as an input to a generative machine-learned model to generate the travel itinerary relating to a trip request (e.g., an image of one or more maps including geographic areas relating to the trip request, a (real-time) image of a POI, etc.).

In accordance with example embodiments described herein, the server computing system 300 can include one or more processors 310 and one or more memory devices 320 as described herein. The server computing system 300 may also include a navigation and mapping system 330 which is similar to the navigation and mapping system 130 described herein.

For example, the navigation and mapping system 330 may include a travel itinerary application 332 which performs functions similar to those discussed above with respect to travel itinerary application 132. In some implementations, one or more machine-learned models associated with the navigation and mapping system 330 may be configured to process a user input to generate information (e.g., semantic information) which can then be provided as an input to one or more other machine-learned models (e.g., generative machine-learned models) associated with the navigation and mapping system 330, to generate the content to be included in the travel itinerary.

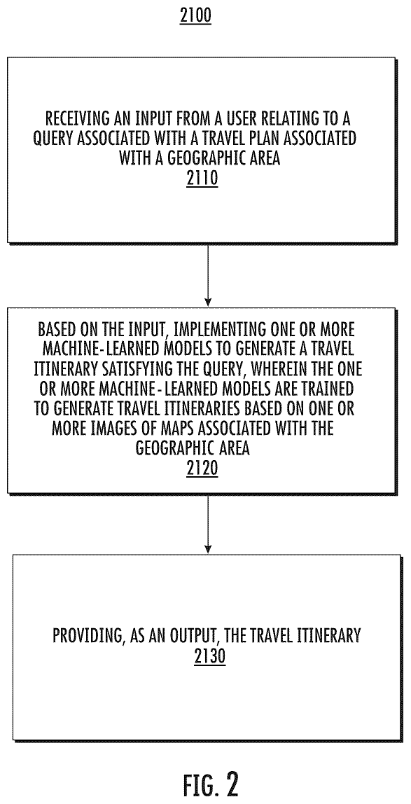

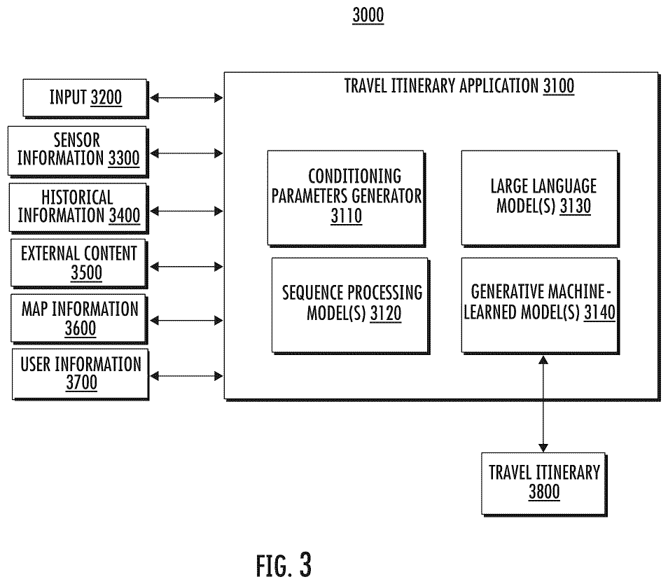

Examples of the disclosure are also directed to computer implemented methods for generating a travel itinerary in response to receiving a user query or input and using one or more generative machine-learned models. FIG. 2 illustrates a flow diagram of an example, non-limiting computer-implemented method, according to one or more example embodiments of the disclosure. FIG. 3 illustrates a block diagram of a travel itinerary application, according to one or more example embodiments of the disclosure.

The flow diagram of FIG. 2 illustrates a method 2100 for generating a travel itinerary via one or more machine-learned models in response to receiving an input. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 2, at operation 2110 the method 2100 includes a computing device receiving an input from a user relating to a query associated with a travel plan associated with a geographic area. As described herein, the computing device may be embodied as computing device 100, server computing system 300, or combinations thereof. For example, the input may be provided by the user via input device 150. For example, the input may be in the form of a question, command, or description. For example, the input may be a text query that specifies one or more points-of-interest associated with the geographic area. For example, a user may provide a query to the computing device relating to one or more locations or geographic areas and can be of varying degrees of complexity. Example trip requests which are brief can include trip requests such as “oahu itinerary 5 days for bachelors” or “plan me a 3 day trip to Salt Lake City with my kids.” An example query which is lengthier and more detailed can include a trip request such as “plan me a 3 day trip to Salt Lake City with my kids (we come from the east coast so there's that time zone difference that would make us wonder if there are places we can go when we wake up at 5am—we might also need to rent an apartment with a kitchen so we can cook our own breakfast assuming no restaurants open that early?! and correspondingly trying to avoid late hour activities, and of course we might be more energetic in the morning and kids might need a nap in the afternoon.” The input may be provided or input to navigation application 134, navigation application 334, travel itinerary application 132, or travel itinerary application 332, for example.

In some implementations, a response to the input may be processed at computing device 100 without involving the server computing system 300. In some implementations, the input may be transmitted from computing device 100 to server computing system 300 and at least part of the response to the input may be processed by the server computing system 300. For example, the input relating to the location may be associated with various conditions (e.g., a particular time, particular POIs of interest, particular geographic areas of interest, particular modes of travel, particular budget constraints, particular dietary constraints, particular user preferences, and the like). For example, travel itinerary application 132 may be configured to generate a customized travel itinerary which satisfies user preferences and/or user conditions or specifications, and which is also feasible and efficient (e.g., minimizes travel time). For example, travel itinerary application 332 may be configured to generate a portion of the customized travel itinerary.

At operation 2120, the computing device may be configured to, based on the input, implement one or more machine-learned models to generate a travel itinerary satisfying the query, wherein the one or more machine-learned models are trained to generate travel itineraries based on one or more images of maps associated with the geographic area. For example, referring to FIG. 3, travel itinerary application 3100 (which may correspond to travel itinerary application 132 and/or travel itinerary application 332) may include a conditioning parameters generator 3110, one or more sequence processing models 3120, one or more large language models 3130, and one or more generative machine-learned models 3140. The travel itinerary application 3100 may receive an input 3200 from a user as discussed above with respect to operation 2110 of FIG. 2. Conditioning parameters generator 3110 may be configured to generate conditioning parameters based at least in part on the input 3200, wherein the conditioning parameters provide values for one or more conditions associated with a travel itinerary associated with a geographic area, which is to be generated based on the input 3200.

To generate the conditioning parameters, the conditioning parameters generator 3110 may be configured to retrieve current values for the one or more conditions at the location. In some implementations, the conditioning parameters generator 3110 may be configured to retrieve current values for the one or more conditions associated with the geographic area based on various information including sensor information 3300, historical information 3400, external content 3500, map information 3600, user information 3700, etc. For example, one or more sensors may be provided at the computing device or may be provided externally (e.g., sensors disposed at the geographic area) and can provide information regarding a state of the geographic area. For example, historical information 3400 may include information relating to previous travel itineraries, relating to previous inputs, relating to previous data associated with POIs that form part of the travel itinerary, etc. For example, external content 3500 may include information relating to POIs including hours of operation for a location to be visited during the trip, costs associated with visiting a POI, costs associated with travelling to a location during the trip, information regarding seasonal or special events associated with the geographic area, information associated with activities (e.g., recreational activities, entertainment activities, etc.) associated with the geographic area, etc. For example, map information 3600 may include information relating to travel routes associated with the geographic area, transportation schedules (e.g., flight schedules, train schedules, bus schedules, etc.), images of the geographic area, etc. For example, user information 3700 may include information about the user and/or information about fellow travelers that are relevant to the travel itinerary. The information can include user preferences and other data as described with respect to user data store 370.

In some implementations, the conditioning parameters generator 3110 may be configured to retrieve current values associated with travel data, traffic data, noise data, occupancy data, etc., for various conditions (e.g., a travel reservation condition, a traffic condition, a noise condition, an occupancy condition, etc.) at one or more locations in one or more geographic areas.

In some implementations, to generate the conditioning parameters, the conditioning parameters generator 3110 may be configured to extract the values for the one or more conditions from the input. The input may include information indicative of the user's intent or requirements. In some implementations, the conditioning parameters generator 3110 (or the one or more sequence processing models 3120 or the one or more large language models 3130) may be configured to extract information from the input 3200 to identify values for the one or more conditions associated with the geographic area, and the conditioning parameters generator 3110 may be configured to generate the conditioning parameters based on the extracted values. For example, the input itself may identify a trip duration (e.g., “3 day trip”) or an attribute or feature (e.g., “quiet restaurant”) that can be used to generate the conditioning parameters.

To generate the conditioning parameters, the conditioning parameters generator 3110 may be configured to infer the values for the one or more conditions from the input. The input may include information indicative of the user's intent or requirements. In some implementations, the conditioning parameters generator 3110 (or the one or more sequence processing models 3120 or the one or more large language models 3130) may be configured to infer information from the input 3200 to identify values for the one or more conditions at the location, and the conditioning parameters generator 3110 may be configured to generate the conditioning parameters based on the inferred values. For example, the input may include a reference to “quiet restaurant” and the conditioning parameters generator 3110 (or the one or more sequence processing models 3120 or the one or more large language models 3130) may be configured to infer a dining establishment having a noise level below a certain threshold value (e.g., based on sensor data that indicates a real-time and/or average decibel level below a threshold value at a time that the user intends to visit the restaurant).

In some implementations, the conditioning parameters generator 3110 may be configured to infer the values for the one or more conditions from the input by providing the input to one or more sequence processing models 3120, wherein the one or more sequence processing models 3120 are configured to output the values for the one or more conditions in response to or based on the query. The one or more sequence processing models 3120 may include one or more machine-learned models which are configured to process and analyze sequential data and to handle data that occurs in a specific order or sequence, including time series data, natural language text, or any other data with a temporal or sequential structure.

The one or more sequence processing models 3120 may receive an input including text and tokenize the input by breaking down the sequence of text into small units (tokens) to provide a structured representation of the input sequence. The one or more sequence processing models 3120 may represent the tokens as vectors in a continuous vector space by mapping each token to a high-dimensional vector, where the relationships between tokens (words) are reflected in the geometric relationships between their corresponding vector. For example, the one or more sequence processing models 3120 may receive an input including the text “3 day trip to Salt Lake City with my kids” and tokenize the input by breaking down the sequence of text into small units (tokens) (e.g., “3 day trip,” “Salt Lake City,” and “kids”), thereby providing a structured representation of the input sequence. In a word embedding, semantically similar words are closer together in the vector space. For example, the vectors for “kids” and “children” might be close to each other because of their semantic relationship, while the vectors for “kids” and “adults” may be far apart.

For example, the input may include a request to provide a customized travel itinerary relating to a travel plan requested by the user. As an example, the one or more sequence processing models 3120 may be configured to tokenize and embed the input and infer a value for the term “busy” based on the query, based on semantic relationships with other vectors in the vector space, and based on other data that is represented as vectors in the vector space (e.g., input sequence data which may include raw data relating to what may generally be considered as a busy restaurant) to infer that a restaurant which is at least 80% full compared to a known capacity of the restaurant can be considered to be busy, or having a current wait time longer than 30 minutes is considered to be busy, or having a noising level above a certain threshold value is considered to be busy, or having no available reservations is considered to be busy, etc.

To generate the conditioning parameters, the conditioning parameters generator 3110 may be configured to predict future values for the one or more conditions based on current values for the one or more conditions at the location and/or based on historical values (e.g., from historical information 3400) for the one or more conditions at the location. The input may include information indicative of the user's intent or requirements. In some implementations, the conditioning parameters generator 3110 (or the one or more sequence processing models 3120 or the one or more large language models 3130) may be configured to predict future values for the one or more conditions at the location, and the conditioning parameters generator 3110 may be configured to generate the conditioning parameters based on the predicted future values. For example, the input may indicate that the user would like a travel itinerary for a future time or date, and the conditioning parameters generator 3110 (or the one or more sequence processing models 3120 or the one or more large language models 3130) may be configured to predict values for the one or more conditions at the location according to the input. In some implementations, the conditioning parameters generator 3110 may be configured to retrieve current values for the one or more conditions at the location based on sensor information 3300 which may correspond to data output by one or more sensors or based on external content 3500 (e.g., information extracted from websites or other sources of information which may include map information). The one or more sensors may be provided at the computing device or be provided externally (e.g., sensors provided at external computing devices disposed at the location). For example, current values associated with traffic data, travel reservation data, noise data, occupancy data, etc., may be retrieved by the conditioning parameters generator 3110 for various conditions (e.g., a traffic condition, a travel reservation condition, a noise condition, an occupancy data, etc.) at the location. In some implementations, the conditioning parameters generator 3110 may be configured to retrieve historical values (e.g., from historical information 3400) for the one or more conditions associated with the applicable geographic areas based on historical information 3400 which may be stored at or associated with various computing devices (e.g., one or more of computing device 100, external computing device 200, server computing system 300, external content 500, POI data store 350, user data store 370, etc.). For example, historical values may be retrieved by the conditioning parameters generator 3110 for various conditions at one or more locations associated with the travel itinerary.

For example, the travel itinerary application 3100 (e.g. conditioning parameters generator 3110) may be configured to implement one or more machine-learned models to predict future values for one or more conditions based on current values and/or historical values for the one or more conditions For example, the travel itinerary application 3100 may be configured to utilize one or more forecasting methods (e.g., linear regression, autoregressive-integrated moving average models, exponential smoothing state space models) and/or neural networks (long short-term memory networks, gated recurrent unit networks, feedforward neural networks, etc.) for predicting values for the one or more conditions based on current values and/or historical values for the one or more conditions. Thus, to generate a customized travel itinerary that satisfies a particular condition relating to a location that forms part of the travel itinerary, (e.g., a closed or open state of a restaurant, a traffic condition of a route, etc.) according to one or more predicted future values, the travel itinerary application 3100 may be configured to generate a customized travel itinerary based on a predicted future values for one or more conditions (e.g., a predicted value for a traffic condition based on historical traffic information and current traffic information).

As described herein, the computing device may be configured to, based on the input, implement one or more machine-learned models to generate the travel itinerary satisfying the query, where the one or more machine-learned models are trained to generate travel itineraries based on one or more images of maps associated with the geographic area. For example, the one or more generative machine-learned models 3140 may be configured to generate the travel itinerary by processing the input 3200 (e.g., via the conditioning parameters generator 3110, one or more sequence processing models 3120, and one or more large language models 3130) to tokenize the input and identify conditions that are relevant to the query, and output a travel itinerary 3800 which satisfies the specifications of the user and is efficient and feasible. For example, to generate a feasible and efficient travel itinerary, the one or more generative machine-learned models 3140 may be configured to process, as an input, one or more maps associated with the geographic area which provides spatial understanding to the one or more generative machine-learned models 3140 which can improve a capability of the one or more generative machine-learned models 3140 to generate routing of the travel itinerary. In some implementations, the image of the map is provided as an input to the one or more machine-learned models (e.g., the one or more large language models 3130, the one or more generative machine-learned models 3140, etc.), and based on the input from the user relating to the query associated with the travel plan associated with the geographic area and the image of the map including the geographic area, the one or more machine-learned models may be implemented to generate the travel itinerary satisfying the query. In some implementations, the one or more machine-learned models (e.g., the one or more large language models 3130, the one or more generative machine-learned models 3140, etc.) may be configured to process the image of the map including the geographic area to recognize a plurality of map features including one or more points-of-interest, one or more geographic terrain features, or one or more road networks. Based on the input from the user relating to the query associated with the travel plan associated with the geographic area, the image of the map including the geographic area, and the plurality of map features, the one or more machine-learned models (e.g., the one or more large language models 3130, the one or more generative machine-learned models 3140, etc.) may be implemented to generate the travel itinerary satisfying the query.

At operation 2130, the computing device may be configured to provide, as an output, a travel itinerary. For example, the travel itinerary 3800 may be generated via the one or more generative machine-learned models 3140 and may include a plurality of locations that are to be travelled to by the user over a particular duration of time (e.g., over the course of a day, a few days, a week, etc.). The travel itinerary 3800 can also include a particular schedule with one or more POIs selected via the one or more large language models 3130 and/or one or more generative machine-learned models 3140 that are to be visited by the user as part of the travel itinerary 3800. In some implementations, the POIs can include dining establishments, entertainment venues (e.g., concerts, sporting events, amusement parks, museums, landmarks, etc.), lodging accommodations (e.g., hotels, rentals, etc.), transportation destinations (e.g., rental car locations, airports, train stations, bus stations, etc.), etc. In some implementations, the travel itinerary 3800 can include a schedule which outlines an order of events including a time for travel, a time spent at each POI, a time for rest or sleep, etc. In some implementations, the travel itinerary 3800 can include estimated costs associated with the travel itinerary 3800 such as travel costs, lodging costs, entertainment costs, dining costs, etc. In some implementations, the one or more generative machine-learned models 3140 may be configured to represent the travel itinerary 3800 graphically by depicting one or more travel routes on the map that form the travel itinerary 3800. For example, the travel routes can be displayed in a particular manner specified by the user, or in a default manner, etc.

The one or more generative machine-learned models 3140 may include a deep neural network or a generative adversarial network (GAN), variational autoencoders, stable diffusion machine-learned models, visual transformers, neural radiance fields (NeRFs), etc., to generate the travel itinerary 3800 which can be depicted visually (e.g., by overlaying travel routes on a map). In some implementations, the visual depiction can also include features with values for conditions associated with the travel itinerary 3800 (e.g., an estimated travel time, names of POIs, costs associated with a travel route or POI, etc.). For example, the computing device or a computing system may include one or more databases (e.g., machine-learned model data store 380) which is configured to store a plurality of generative machine-learned models respectively associated with a plurality of different geographic areas. In some implementations, the computing device may be configured to retrieve, from among the plurality of generative machine-learned models, a generative machine-learned model associated with a particular geographic area relating to the input. In some implementations, the generative machine-learned model may be fine-tuned based on a large parameter generative machine-learned model (e.g., having a greater number of parameters than the generative machine-learned model).

In some implementations, the one or more generative machine-learned models 3140 may be trained on a large dataset of digital maps (e.g., images of maps) with corresponding information about the conditions associated with each digital map. These conditions could include variables including a particular time, season, budget constraints, time constraints, modes of travel, user preferences, dietary restrictions, occupancy information, traffic information, noise information, etc. During training, the one or more generative machine-learned models 3140 may be configured to learn relationships between the visual elements in a digital map and conditions that influence them. This may involve the computing device adjusting each generative machine-learned model's internal parameters to generate realistic (feasible), efficient, and accurate travel routes between locations in a geographic area based on the training data that satisfy a query. In some implementations, the one or more generative machine-learned models 3140 may be trained on one or more training datasets including a plurality of reference or ground truth travel itineraries for a set of POIs in a particular geographic area. The one or more training datasets may include values for the one or more conditions for at least some of the plurality of reference travel itineraries.

In some implementations, the one or more generative machine-learned models 3140 are configured to generate the travel itinerary 3800 based on the geographic area as indicated in the input and the values for one or more conditions associated with features to be satisfied according to the input. For example, if the query indicates a particular duration of time for the trip (e.g., three days), the one or more generative machine-learned models 3140 may be configured to generate the travel itinerary 3800 by conditioning the one or more generative machine-learned models 3140 with the conditioning parameters. For example, the one or more generative machine-learned models 3140 may be configured to consider the conditioning parameters (and corresponding values for the one or more conditions) to make decisions for generating the travel itinerary 3800. For example, in some implementations the one or more generative machine-learned models 3140 may be configured to utilize an existing or pre-stored base travel itinerary (default travel itinerary) for a particular geographic area for a particular duration of time, and then generate a customized travel itinerary by modifying the existing or pre-stored base travel itinerary which satisfies particular conditions specified or implied in the input (e.g., matching the criteria provided in the input 3200 and conditioning parameters generated by the conditioning parameters generator 3110).

At operation 2130, the computing device may be configured to provide the travel itinerary 3800 satisfying the input 3200. For example, the input may include a text or voice query that specifies a travel plan associated with a geographic area and may include various conditions or parameters (e.g., a duration of time for the trip, activities to be conducted, modes of travel, limitations on the trip such as budget constraints, time constraints, dietary restrictions, etc.) and the travel itinerary 3800 which is generated may depict the travel routes forming the travel itinerary 3800 along with other information. For example, the travel itinerary 3800 may be provided for presentation on the display device 160 of computing device 100. In some implementations, the server computing system 300 may provide (transmit) the travel itinerary 3800 or a portion of the travel itinerary 3800 to computing device 100 or the server computing system 300 may provide access to the travel itinerary 3800 to the computing device 100. For example, the generated travel itinerary 3800 may be stored at one or more computing devices (e.g., one or more of computing device 100, external computing device 200, server computing system 300, external content 500, POI data store 350, user data store 370, etc.).

In some implementations, after the travel itinerary 3800 is generated, the user can provide feedback or a further input to refine or change the travel itinerary 3800, and operations 2110 through 2130 can be repeated such that the computing device is configured to generate, using the one or more generative machine-learned models, an adjusted (refined, modified, improved, updated, etc.) travel itinerary 3800, for example, in real-time. The adjusted customized travel itinerary 3800 can include one or more customized features as further specified by the user in the further input. In some implementations, after the travel itinerary 3800 is generated, the computing device (e.g., the travel itinerary application 3100) can be configured to automatically evaluate the travel itinerary 3800 and generate feedback, and operations 2110 through 2130 can be repeated such that the computing device is configured to generate, using the one or more generative machine-learned models and the image of the map, an adjusted (refined, modified, improved, updated, etc.) travel itinerary 3800, for example, in real-time.

In some implementations, the output travel itinerary 3800 may be provided to other computing systems or applications (e.g., navigation application 134). Based on the content of the travel itinerary 3800, the navigation application 134 may be executed to control navigation functions to implement the routing associated with the travel itinerary 3800. In some implementations, a vehicle may receive the travel itinerary 3800 and be controlled to route the vehicle according to the locations identified in the travel itinerary 3800. In some implementations, other applications may be implemented or executed to carry out the travel plan associated with the travel itinerary 3800. For example, based on the content of the travel itinerary 3800, travel applications may be executed to reserve lodging accommodations, reserve transportation, reserve entertainment, etc.

In the examples described with respect to FIGS. 2 and 3, the computing device may dynamically (e.g., in real-time) generate the travel itinerary 3800 relating to a travel plan indicated in a query received from a user associated with a particular geographic area location (e.g., at operation 2110). In some implementations however, a travel itinerary which satisfies the request received at operation 2110 may be prestored or preexisting and may be stored at one or more computing devices (e.g., one or more of computing device 100, external computing device 200, server computing system 300, external content 500, POI data store 350, user data store 370, etc.). Therefore, in such a case operation 2120 may be omitted while an operation of searching for the travel itinerary which satisfies the conditions of the input may be performed as an intermediate operation between operations 2110 and 2130. Accordingly, the responsiveness of the computing device to the request may be faster as less operations are performed or needed.

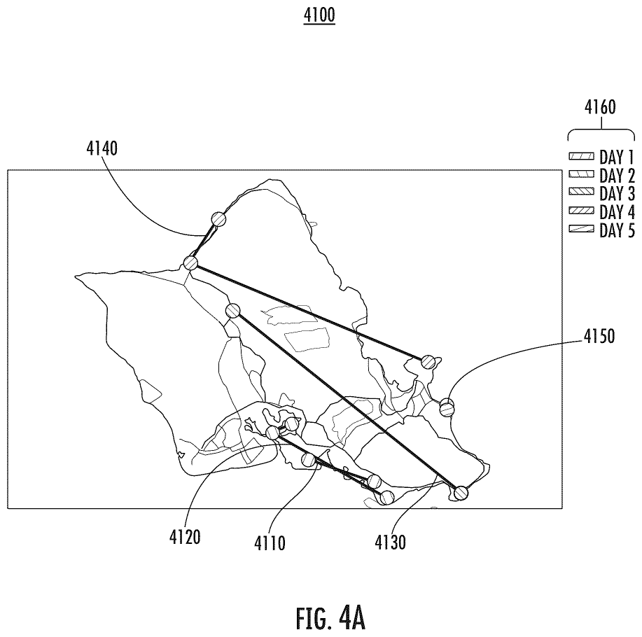

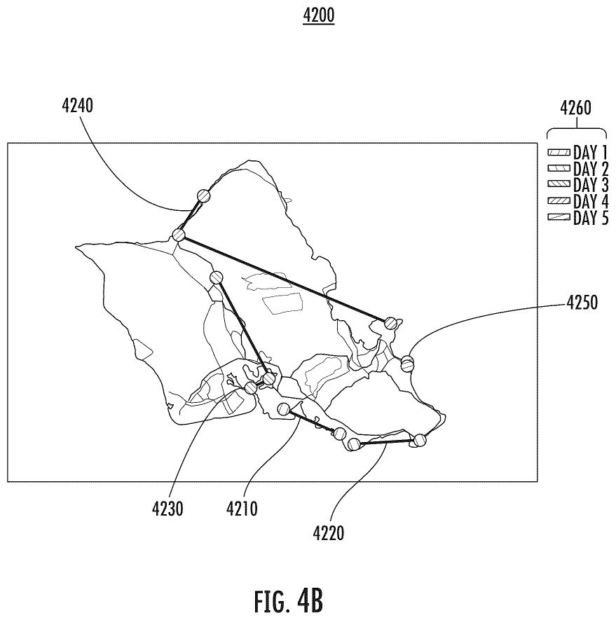

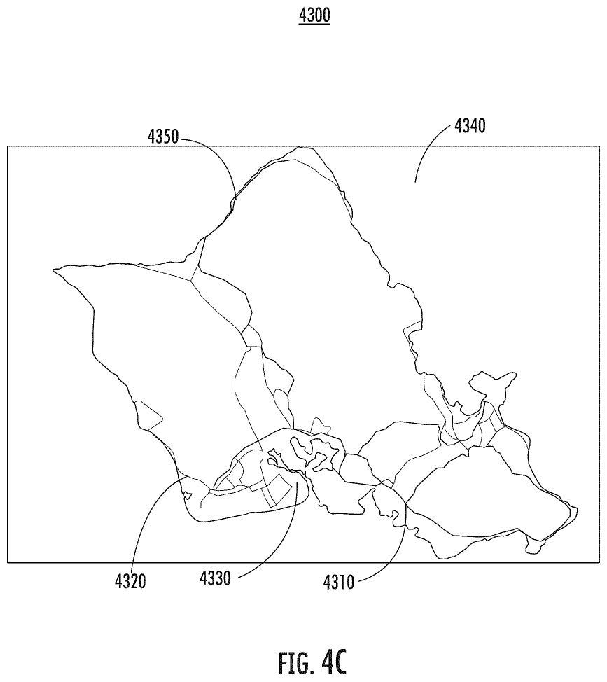

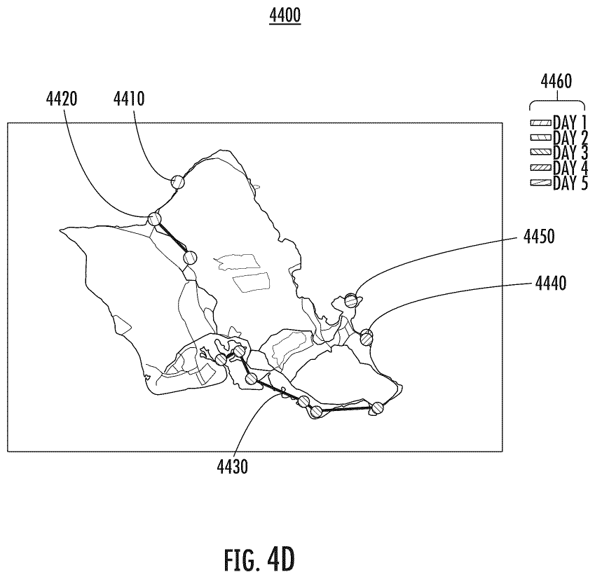

Examples of the disclosure are also directed to user-facing aspects by which a user can request a travel itinerary associated with a geographic location. FIGS. 4A-4D illustrate example maps of a travel itinerary application and/or a mapping or navigation application, according to one or more example embodiments of the disclosure. For example, FIG. 4A illustrates a first example of generating a travel itinerary relating to a geographic area which is overlaid on a map and which can be presented on a display device associated with a user, according to one or more example embodiments of the disclosure.

For example, FIG. 4A illustrates a user interface screen 4100 of a travel itinerary application (or of a mapping or navigation application), according to one or more example embodiments of the disclosure. In FIG. 4A, user interface screen 4100 depicts a map of a location or geographic area (e.g., Oahu) and includes a plurality of travel routes which form a travel itinerary. In the example of FIG. 4A, the travel itinerary is generated by one or more machine-learned models (e.g., one or more generative machine-learned models) based on only the user query of “oahu itinerary 5 days for bachelors”.

As shown in FIG. 4A, the travel itinerary 4160 encompasses five days including travel routes for a first day 4110, a second day 4120, a third day 4130, a fourth day 4140, and a fifth day 4150. However, the routing of the travel itinerary 4160 is inefficient as many POIs can be better clustered together to reduce travel time within a day.

For example, FIG. 4B illustrates a second example of generating a travel itinerary relating to a geographic area which can be presented on a display device associated with a user, according to one or more example embodiments of the disclosure. In contrast to the example of FIG. 4A, in the example of FIG. 4B the one or more machine-learned models are configured to generate the travel itinerary based on the input received from the user and also based on another input of a map which includes the geographic area associated with the query from the user.

For example, FIG. 4B illustrates a user interface screen 4200 of a travel application (or of a mapping or navigation application), according to one or more example embodiments of the disclosure. In FIG. 4B, user interface screen 4200 depicts a map of a location or geographic area (e.g., Oahu) and includes a plurality of travel routes which form a travel itinerary. In the example of FIG. 4B, the travel itinerary is generated by one or more machine-learned models (e.g., one or more generative machine-learned models) based on the user query of “oahu itinerary 5 days for bachelors” and an input of a map including the geographic area (e.g., a map of Oahu). For example, the map can include marked POIs (e.g., cities, tourist attractions, hotels, restaurants, etc.), a road network, and prominent geographical features like rivers and mountains. The map may have a grid with scale annotations. In some implementations, the map can be represented as an image.

As shown in FIG. 4B, the travel itinerary 4260 encompasses five days including travel routes for a first day 4210, a second day 4220, a third day 4230, a fourth day 4240, and a fifth day 4250. Compared to the routing of the travel itinerary 4160, the travel distance of the routing of the travel itinerary is reduced by about 22%.

In some implementations, the one or more generative machine-learned models 3140 may be configured to generate a rationale for providing a particular travel itinerary and/or for revising a particular travel itinerary. For example, the one or more generative machine-learned models 3140 may be configured to generate a rationale for revising the travel itinerary output according to the example of FIG. 4A (e.g., on a day-by-day basis). An example explanation for reordering the travel routes shown in FIG. 4A to generate the travel routes shown in FIG. 4B may explain that for Day 2, the “Activities at Diamond Head and Hanauma Bay were grouped together because they are both located on the southeastern side of Oahu, reducing travel time,” for Day 3, “Pearl Harbor and Dole Plantation are closer to each other compared to other attractions, making them feasible for the same day,” for Day 4 the “North Shore beaches, Haleiwa Town, and a North Shore beach bonfire were kept together, as they're all located on the North Shore,” and for Day 5, the “Mokulua Islands and Lanikai Beach, both on the eastern side, were kept on the same day to keep travel short.”

In some implementations, the one or more generative machine-learned models 3140 may be configured to receive a prompt (e.g., an internal prompt) that instructs the one or more generative machine-learned models 3140 to utilize the map to generate a feasible travel itinerary and/or to revise an initially generated travel itinerary. An example prompt may be similar to: “I'm giving you a map of the destination. The map shows the geographic positions of the attractions. Your job is to read the map and revise the original itinerary to be more feasible. Please try to keep all the POIs mentioned in the original itinerary but reorder them to reduce travel time for each day.”

For example, FIG. 4C illustrates an example map 4300 of a geographic area that may be provided to one or more machine-learned models (e.g., the one or more generative machine-learned models 3140) that can be used for generating a travel itinerary relating to the geographic area. In some implementations, the map 4300 can be presented on a display device associated with a user. For example, the image of the map 4300 can include points-of-interest (POIs) such as cities 4310, tourist attractions 4320, hotels 4330, restaurants, etc.), a road network, and prominent geographical features including rivers, lakes, oceans 4340, mountains, canyons, beaches 4350, etc. In some implementations, the one or more machine-learned models (e.g., the one or more large language machine-learned models 3130 and/or the one or more generative machine-learned models 3140) may be configured or trained to identify the POIs and/or geographical features from a map. Therefore, the one or more machine-learned models (e.g., the one or more large language machine-learned models 3130 and/or the one or more generative machine-learned models 3140) may be trained with the capability to directly read images of maps, reason about travel distances between different locations (e.g., different POIs), and plan for an itinerary that optimizes for travel distances. Accordingly, the geospatial understanding of the geographic area including the POIs by the one or more machine-learned models may be improved.

For example, FIG. 4D illustrates a third example of generating a travel itinerary relating to a geographic area which can be presented on a display device associated with a user, according to one or more example embodiments of the disclosure. In contrast to the example of FIG. 4B, in the example of FIG. 4D the one or more machine-learned models are configured to generate the travel itinerary based on the input received from the user and also based on another input of a map which includes the geographic area associated with the query from the user, where the one or more machine-learned models are configured to generate the travel itinerary according to an algorithmic planner such as a traveling salesman problem solver, a vehicle routing problem, heuristic algorithms, etc. In some implementations, the one or more machine-learned models may be trained to generate travel itineraries based on training data which includes images of a plurality of maps which include a plurality of geographic areas.

As shown in FIG. 4D, the travel itinerary 4460 encompasses five days including travel routes for a first day 4410, a second day 4420, a third day 4430, a fourth day 4440, and a fifth day 4450. Compared to the routing of the travel itinerary 4160 and travel itinerary 4260, the travel distance of the routing of the travel itinerary 4460 is reduced and more efficient.

In some implementations, the one or more machine-learned models may be configured to implement a process for generating a feasible and efficient travel itinerary. For example, the one or more machine-learned models may be configured to receive a query to generate a travel itinerary. The one or more machine-learned models may be configured to generate an initial travel itinerary. A process can be performed (e.g., by the computing device including the travel itinerary application) to check for feasibility errors which are reported to the one or more machine-learned models. For example, the computing device (e.g., travel itinerary application 3100) may be configured to evaluate an output travel itinerary to detect a presence of any feasibility errors. Based on the results of the evaluating, the computing device (e.g., travel itinerary application 3100) when the presence of at least one feasibility error is detected, the computing device (e.g., travel itinerary application 3100) may be configured to implement one or more machine-learned models (e.g., the one or more generative machine-learned models 3140) to generate a revised travel itinerary satisfying the query based on the at least one feasibility error, and provide, as a further output, the revised travel itinerary. The one or more machine-learned models may be configured to generate a revised travel itinerary based on the detected feasibility errors. In some implementations, evaluating the travel itinerary to detect the presence of any feasibility errors may include the one or more machine-learned models (e.g., the one or more generative machine-learned models 3140) calling a map application programming interface (API) to determine whether the travel itinerary is feasible and/or to determine whether intermediate determinations are feasible (e.g., whether travel between locations forming part of the travel itinerary is possible or takes less than a threshold duration of time, whether specifications in the input are met such as time constraints, budget constraints, mode of transportation constraints, whether the hours of operation of a POI comport or conflict with the planned schedule, whether the travel route is sensical or has a zig zag pattern, etc.). Example feasibility outputs which could be output regarding the examples of FIGS. 4A-4D could include an output indicating the Polynesian Cultural Center is closed in the morning at the planned time for visiting, an output indicating a particular day (e.g., Day 3 in FIG. 4D) is long (e.g., exceeds a threshold level regarding distance and/or time), an output indicating a travel route has zig-zags, etc. The output can be in the form of natural language, for example.

In some implementations, the one or more machine-learned models may be configured to generate a plurality of candidate travel itineraries. For example, the one or more machine-learned models may be configured to estimate distances (or travel times) between locations forming each respective travel itinerary. Additionally, or alternatively, the one or more machine-learned models may be configured to implement (e.g., call) a tool such as a map or navigation application programming interface (API) to estimate the distances or travel times. The one or more machine-learned models may be configured to rank the plurality of candidate travel itineraries according to their feasibility (e.g., based on the estimated distances and/or travel times). In some implementations, the one or more machine-learned models may be configured to rank the plurality of candidate travel itineraries according to various criteria including their feasibility as well as other factors including user preferences, user specified criteria, costs (e.g., monetary, energy, etc.), hours of operation, modes of transportation, etc. Based on the ranking, the one or more machine-learned models may be configured to output a final plan that is optimized on multiple objectives including for spatial feasibility. In some implementations, the one or more machine-learned models (e.g., a large-language model) may be configured to convert a structured itinerary into text form using natural language.

For example, the one or more machine-learned models may group two locations together as part of a travel itinerary for a first day based upon a close proximity on the map. However, the one or more machine-learned models and/or a tool such as a map or navigation application or API may be configured to determine that travel between the two locations is not feasible or efficient (e.g., due to traffic, construction, geographic constraints such as terrain). For example, whether a travel itinerary or travel between locations is feasible may be determined based on whether travel is possible (e.g., modes of transportation cannot be taken between the locations, geographic features, traffic conditions, weather conditions, etc., make travel impossible) or inefficient (e.g., travel between the locations takes more than a threshold duration of time).

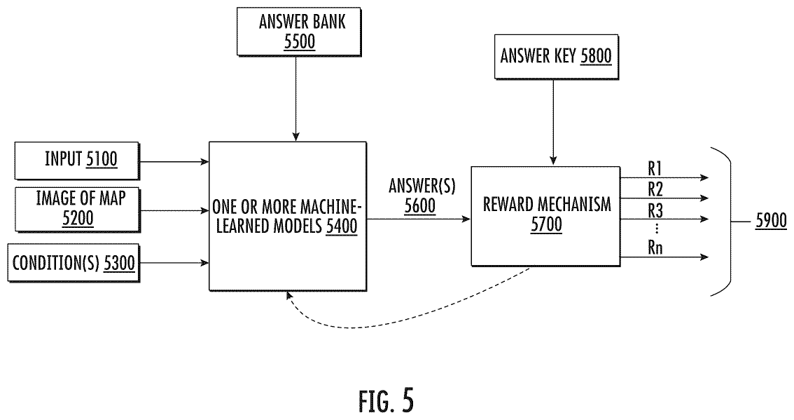

FIG. 5 illustrates an example block diagram of a system for training one or more machine-learned models for a travel itinerary application, according to one or more example embodiments of the disclosure. FIG. 5 illustrates an example system 5000 in which one or more machine-learned models 5400 may be configured to receive as inputs an input 5100 that may be in the form of a query regarding a travel plan and an image of a map 5200 which is associated with a geographic area that is relevant to the travel plan. The one or more machine-learned models 5400 may be configured to receive as further inputs one or more conditions 5300 pertaining to the travel plan which may not be included in the input 5100 but may be inferred or implied (e.g., hours of operation of POIs, user preferences, modes of transportation, etc.). For example, the one or more machine-learned models 5400 may include one or more of the conditioning parameters generator 3110, the one or more sequence processing models 3120, the one or more large language models 3130, and the one or more generative machine-learned models 3140 of FIG. 3.

In some implementations, the one or more machine-learned models 5400 are trained to output one or more answers 5600 relating to a travel itinerary based on the image of the map 5200 and the input 5100. For example, the image of the map 5200 may pertain to one or more regions of interest to the user (e.g., regions in the map relevant to the query). Training the one or more machine-learned models 5400 with images of maps enhances the spatial reasoning capability of the one or more machine-learned models 5400 relating to location and distance signals. Training data for the one or more machine-learned models 5400 can include images of maps which can include points-of-interest (POIs) such as cities, tourist attractions, hotels, restaurants, etc.), a road network, and prominent geographical features including rivers, lakes, oceans, mountains, canyons, etc. Training data for the one or more machine-learned models 5400 can also include questions regarding travelling from a first point to a second point by various methods (e.g., walking, biking, airplane, driving, train, etc.). In some implementations, the one or more machine-learned models 5400 can assess or measure a cost-benefit metric based on geolocation information (e.g., a tradeoff between a travel visit and the value of the visit such as the time or distance needed to travel to the destination compared to a scenic view afforded by the location).

In some implementations, the training data for the one or more machine-learned models 5400 can also include option information in the form of an answer bank 5500 that can be used to assess the performance of the one or more machine-learned models 5400. For example, the answer bank 5500 can include a plurality of candidate answers for a particular question posed to the one or more machine-learned models 5400. In some implementations, the candidate answers can include one or more range values (e.g., 1-2 hours, 5-10 hours, 5-6 hours, 20-30 minutes, etc.). When providing a response to a query (e.g., input 5100) for training, the one or more machine-learned models 5400 may be configured to select all candidate answers which are correct and provide the selected candidate answers as an output (one or more answers 5600) to the reward mechanism 5700. The reward mechanism 5700 may be configured to also receive correct answers associated with the posed question from the answer key 5800 and determine whether the one or more answers 5600 are correct. In some implementations, incorrect answers can be penalized by the reward mechanism 5700 at different gradations according to an accuracy of the prediction. For example, the one or more machine-learned models 5400 may receive a greater penalty for a travel time prediction of 50 hours compared to a prediction of 5 hours, if the actual travel time is 4 hours. As another example, the reward mechanism 5700 may judge or weight the performance of the one or more machine-learned models 5400 differently based on the number of correct answers provided by the one or more machine-learned models 5400 when there are a plurality of candidate answers. As an example, a question posed to the one or more machine-learned models 5400 may relate to the duration of time needed to travel between two locations in the geographic area and the number of correct answers can be determined with reference to a known or correct travel time. As an example, the correct travel time between locations may be four hours and the plurality of candidate answers from which the one or more machine-learned models 5400 can select from may be: a) 1-5 hours; b) 6-10 hours; c) 1-2 hours; d) 3-5 hours; e) 3 hours; f) 4 hours; and g) 5 hours). If the one or more machine-learned models 5400 predicts the travel time is three hours, the one or more machine-learned models 5400 can select options a, d, and e while the correct answer is a, d, and f. Because the answer is partially correct, the reward mechanism 5700 may be configured to award the one or more machine-learned models 5400 with partial credit when assessing the performance (e.g., a greater amount of credit compared to an answer which has no correct answers or fewer correct answers). For example, the reward mechanism 5700 provide feedback 5900 to the one or more machine-learned models 5400 based on the assigned or assessed reward value (e.g., R1, R2, R3 . . . Rn) according to the evaluation of the one or more answers 5600 output by the one or more machine-learned models 5400. The one or more machine-learned models 5400 may be configured to revise the one or more answers 5600 based on the feedback, adjust one or more parameters that are used to process the inputs provided to the one or more machine-learned models 5400, etc. While the question posed to the one or more machine-learned models 5400 was an example related to a travel time between locations in the geographic area, this is only one example, and other training instances may be implemented to train the one or more machine-learned models 5400 to generate a travel itinerary. For example, other questions or queries provided to the one or more machine-learned models 5400 may include asking the one or more machine-learned models 5400 to recognize and identify POIs, geographic features, road networks, etc., from the image of the map 5200 and to select one or more correct answers associated with the question, and evaluating the responses of the one or more machine-learned models 5400 against actual correct answers. For example, other questions or queries provided to the one or more machine-learned models 5400 may include asking the one or more machine-learned models 5400 to generate a travel itinerary and to select one or more correct answers associated with the travel itinerary, and evaluating the responses of the one or more machine-learned models 5400 against actual correct answers associated with an optimal travel itinerary. For example, other questions or queries provided to the one or more machine-learned models 5400 may include asking the one or more machine-learned models 5400 to recognize and select an optimal travel itinerary from a list of candidate travel itineraries, and to select one or more correct answers associated with the optimal travel itinerary (e.g., selecting correct rationales from an answer bank of possible rationales as to why the optimal travel itinerary is superior to other candidate travel itineraries), and evaluating the responses of the one or more machine-learned models 5400 against actual correct answers associated with the optimal travel itinerary.

The description of FIG. 5 relates to an example system 5000 for training the one or more machine-learned models 5400 in which an image of a map 5200 is received. However, it would be understood that the one or more machine-learned models 5400 may receive and be trained on a plurality of images of maps associated with a plurality of geographic areas. In some implementations, the input 5100 may include a text query that specifies one or more points-of-interest associated with the geographic area, and the plurality of images of maps associated with the plurality of geographic areas include the one or more points-of-interest. For example, the one or more machine-learned models 5400 may be trained based on training data including the plurality of images of maps associated with the plurality of geographic areas and by instructing the one or more machine-learned models 5400 to respond to training queries (e.g., via the input 5100) associated with training travel plans associated with the plurality of geographic areas by selecting correct answers from among a plurality of answers (e.g., from the answer bank 5500), the plurality of answers including more than one correct answer and at least one incorrect answer. For example, the training queries associated with the training travel plans associated with the plurality of geographic areas can include questions relating to a time to travel between different points-of-interest depicted in the plurality of images of maps associated with the plurality of geographic areas. For example, the one or more machine-learned models 5400 may be trained based on training data including the plurality of images of maps associated with the plurality of geographic areas and by training the one or more machine-learned models 5400 to recognize and identify points-of-interest depicted in the plurality of images of maps associated with the plurality of geographic areas. In some implementations, the one or more machine-learned models 5400 may be trained to generate a travel itinerary satisfying a training query associated with a training travel plan associated with the plurality of geographic areas, where the travel itinerary minimizes a travel time between different points-of-interest forming at least a part of the travel itinerary, and the different points-of-interest are depicted in at least one of the plurality of images of maps associated with the plurality of geographic areas.

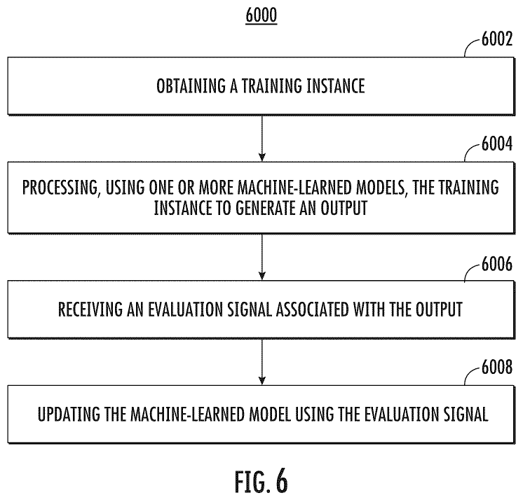

FIG. 6 depicts a flowchart of a method 6000 for training one or more machine-learned models according to aspects of the disclosure. For instance, an example machine-learned model can include one or more of a VLM, LLM, a generative machine-learned model, etc. For example, the one or more machine-learned models may be configured to implement the operations of FIGS. 2-3, of the travel itinerary applications as described herein.

FIG. 6 is a flow chart diagram illustrating an example method for training a machine-learned model according to example implementations of aspects of the disclosure. One or more portion(s) of example method 6000 can be implemented by a computing system that includes one or more computing devices such as, for example, computing systems described with reference to the other drawings. Each respective portion of example method 6000 can be performed by any (or any combination) of one or more computing devices. Moreover, one or more portion(s) of example method 6000 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the disclosure. FIG. 6 is described with reference to elements/terms described with respect to other systems and drawings for exemplary illustrated purposes and is not meant to be limiting. One or more portions of example method 6000 can be performed additionally, or alternatively, by other systems.

At 6002, example method 6000 can include obtaining a training instance. A set of training data can include a plurality of training instances divided between multiple datasets (e.g., a training dataset, a validation dataset, or testing dataset). A training instance can be labeled or unlabeled. Although referred to in example method 6000 as a “training” instance, it is to be understood that runtime inferences can form training instances when a model is trained using an evaluation of the model's performance on that runtime instance (e.g., online training/learning). Example data types for the training instance and various tasks associated therewith are described throughout the disclosure.

At 6004, example method 6000 can include processing, using one or more machine-learned models, the training instance to generate an output. The output can be directly obtained from the one or more machine-learned models or can be a downstream result of a chain of processing operations that includes an output of the one or more machine-learned models.

At 6006, example method 6000 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 6008, example method 6000 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 6000 can include implementing a number of generalization techniques (e.g., weight decays, dropouts, etc.) to improve the generalization capability of the models being trained.

In some implementations, example method 6000 can be implemented for training a machine-learned model from an initialized state to a fully trained state (e.g., when the model exhibits a desired performance profile, such as based on accuracy, precision, recall, etc.).

In some implementations, example method 6000 can be implemented for particular stages of a training procedure. For instance, in some implementations, example method 6000 can be implemented for pre-training a machine-learned model. Pre-training can include, for instance, large-scale training over potentially noisy data to achieve a broad base of performance levels across a variety of tasks/data types. In some implementations, example method 6000 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

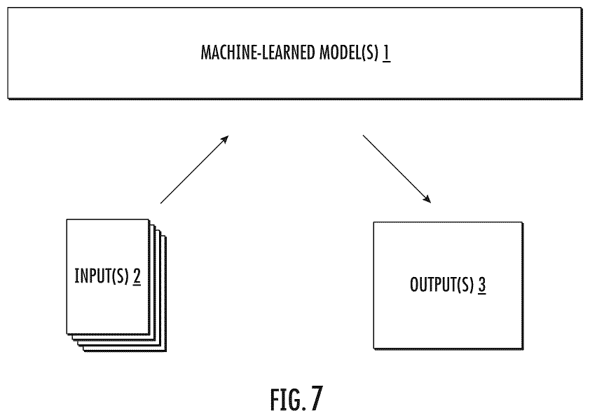

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the disclosure are not limited to those examples noted above.

### Example Machine-Learned Sequence Processing Models

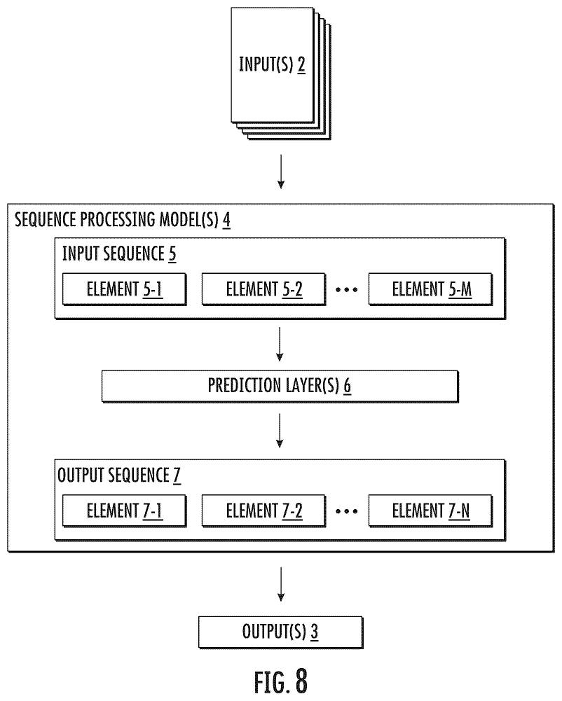

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

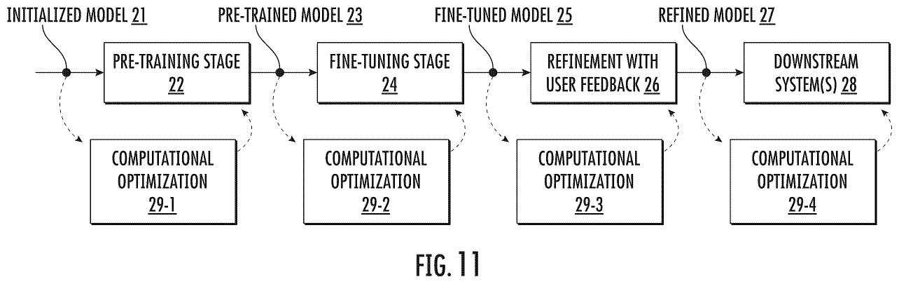

In general, arbitrary data types can be serialized and processed into input sequence 5. It is to be understood that element(s) 5-1, 5-2, . . . , 5-M depicted in FIG. 11 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

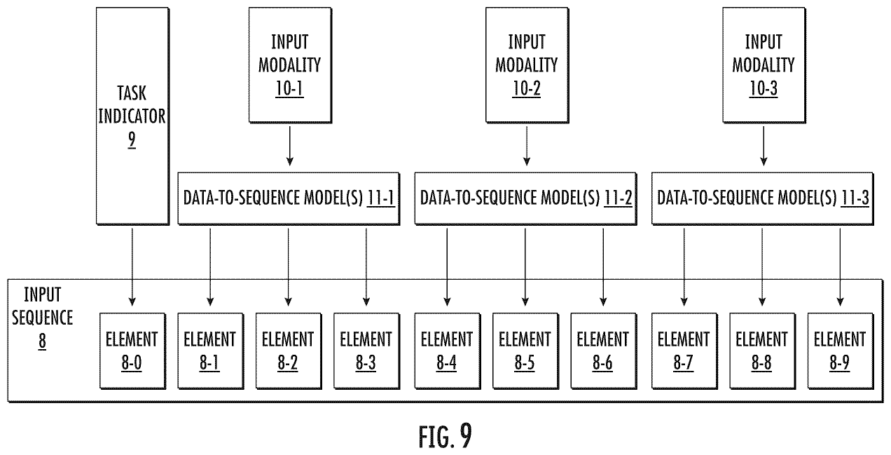

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

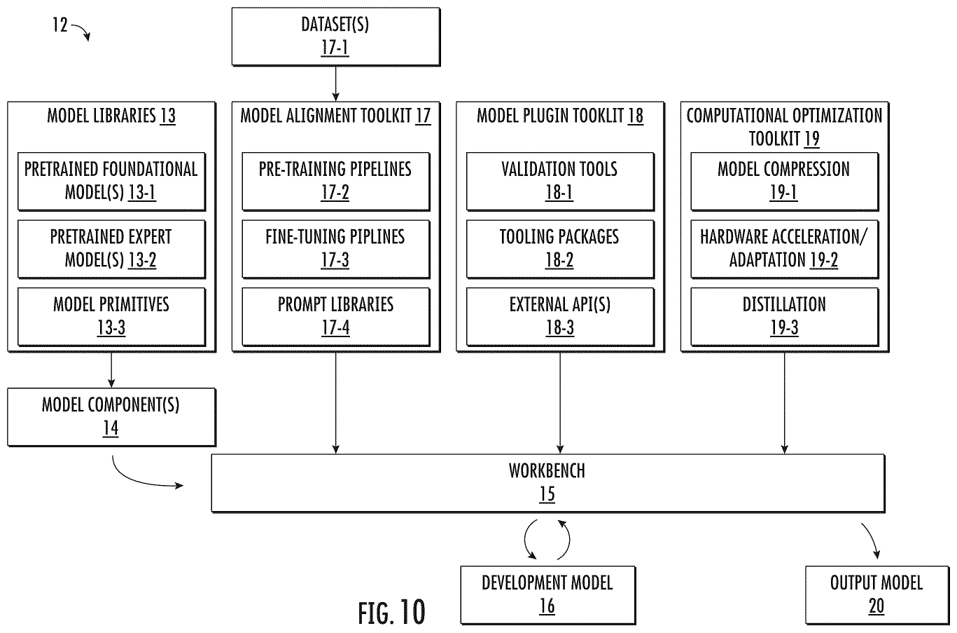

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 6000 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

FIG. 11 is a block diagram of an example training flow for training a machine-learned development model 16. One or more portion(s) of the example training flow can be implemented by a computing system that includes one or more computing devices such as, for example, computing systems described with reference to the other drawings. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the disclosure. FIG. 11 is described with reference to elements/terms described with respect to other systems and drawings for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

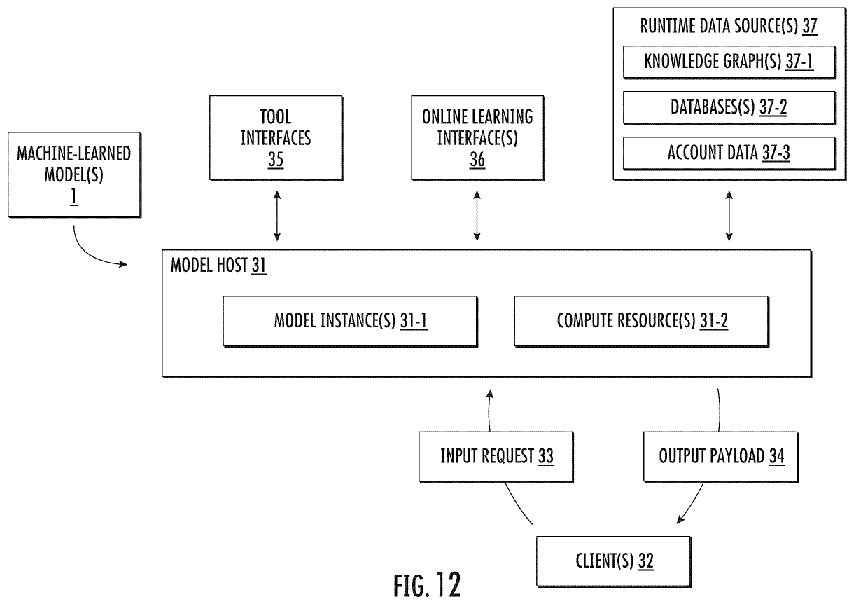

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

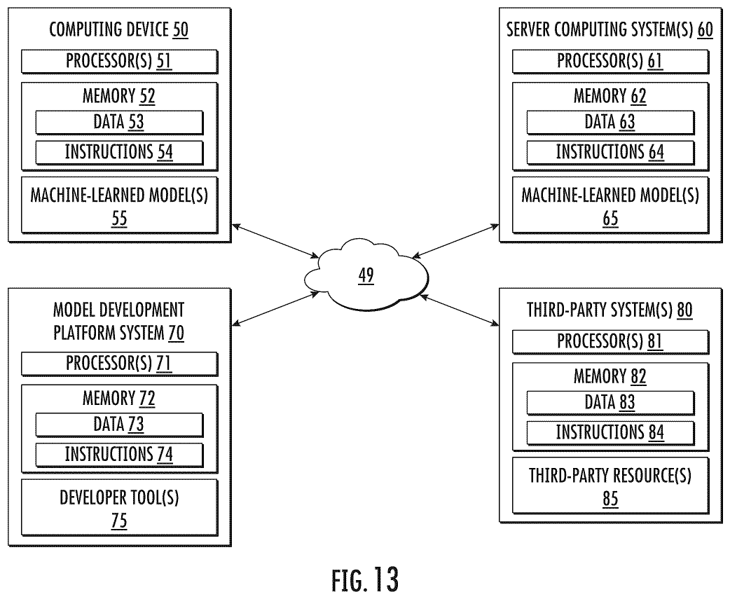

FIG. 13 is a block diagram of an example networked computing system that can perform aspects of example implementations of the disclosure. The system can include a number of computing devices and systems that are communicatively coupled over a network 49. An example computing device 50 is described to provide an example of a computing device that can perform any aspect of the disclosure (e.g., implementing model host 31, client(s) 32, or both). An example server computing system 60 is described as an example of a server computing system that can perform any aspect of the disclosure (e.g., implementing model host 31, client(s) 32, or both). Computing device 50 and server computing system(s) 60 can cooperatively interact (e.g., over network 49) to perform any aspect of the disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 13 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 13 illustrates one example arrangement of computing systems that can be used to implement the disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

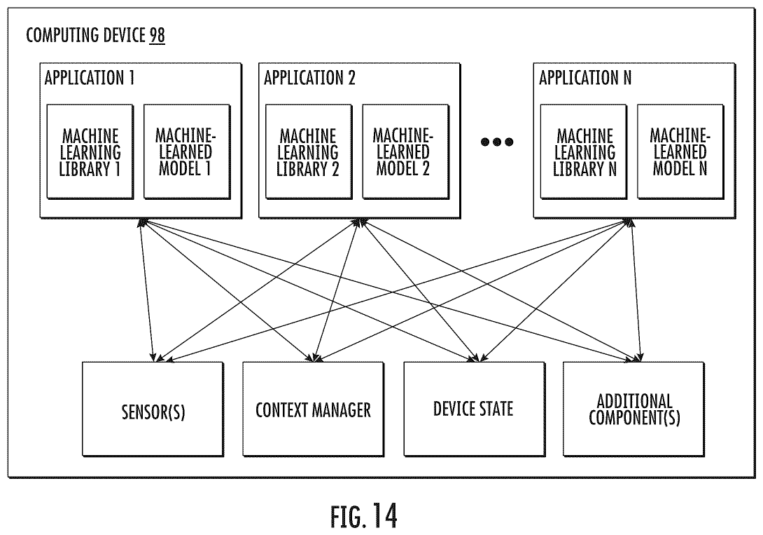

FIG. 14 is a block diagram of an example computing device 98 that performs according to example embodiments of the disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a content generation application, a travel itinerary application, a text messaging application, an email application, a dictation application, a virtual keyboard application, a browser application, a social media application, a chat application, a navigation or mapping application, etc. As illustrated in FIG. 14, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

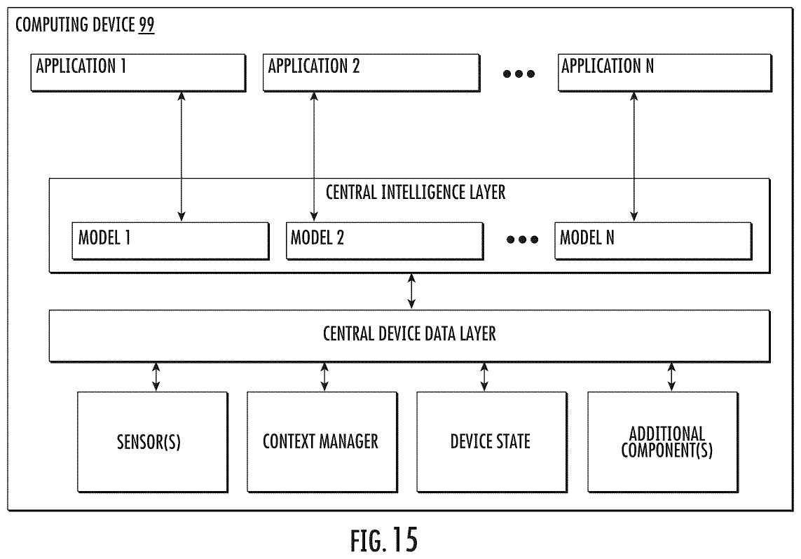

FIG. 15 is a block diagram of an example computing device 99 that performs according to example embodiments of the disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a content generation application, a travel itinerary application, a text messaging application, an email application, a dictation application, a virtual keyboard application, a browser application, a social media application, a chat application, a navigation or mapping application, etc. In some implementations, each application can communicate with the central intelligence layer (and model(s) stored therein) using an API (e.g., a common API across all applications).

The central intelligence layer can include a number of machine-learned models. For example, as illustrated in FIG. 15, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the disclosure is by way of example rather than by way of limitation, and the subject disclosure does not preclude inclusion of such modifications, variations or additions to the disclosure as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, numbers, steps, operations, elements, components, or combinations thereof.

The term “and / or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the disclosure.

To the extent terms including “module”, and “unit,” and the like are used herein, these terms may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks, Blu-Ray disks, and DVDs; magneto-optical media such as optical discs; and other hardware devices that are specially configured to store and perform program instructions, such as semiconductor memory, read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules in order to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the non-transitory computer-readable storage media may also be embodied in at least one application specific integrated circuit (ASIC) or Field Programmable Gate Array (FPGA).

Each block of the flowchart illustrations may represent a unit, module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently (simultaneously) or the blocks may sometimes be executed in the reverse order, depending upon the functionality involved.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While the disclosure has been described with respect to various example embodiments, each example is provided by way of explanation, not limitation of the disclosure. Those skilled in the art, upon attaining an understanding of the foregoing, can readily produce alterations to, variations of, and equivalents to such embodiments. Accordingly, the disclosure does not preclude inclusion of such modifications, variations and/or additions to the disclosed subject matter as would be readily apparent to one of ordinary skill in the art. For example, features illustrated or described as part of one embodiment can be used with another embodiment to yield a still further embodiment. Thus, it is intended that the disclosure covers such alterations, variations, and equivalents.

What is claimed is:

1. A computing system for generating a travel itinerary, comprising:
one or more memories configured to store instructions; and
one or more processors configured to execute the instructions to perform operations, the operations comprising:
receiving an input from a user relating to a query associated with a travel plan associated with a geographic area;
based on the input, implementing one or more machine-learned models to generate a travel itinerary satisfying the query, wherein the one or more machine-learned models are trained to generate travel itineraries based on a plurality of images of maps associated with a plurality of geographic areas; and
providing, as an output, the travel itinerary.

2. The computing system of claim 1, wherein
the input comprises a text query that specifies one or more points-of-interest associated with the geographic area, and
the plurality of images of maps associated with the plurality of geographic areas include the one or more points-of-interest.

3. The computing system of claim 1, wherein the one or more machine-learned models are trained based on training data including the plurality of images of maps associated with the plurality of geographic areas and by instructing the one or more machine-learned models to respond to training queries associated with training travel plans associated with the plurality of geographic areas by selecting correct answers from among a plurality of answers, the plurality of answers including more than one correct answer and at least one incorrect answer.

4. The computing system of claim 3, wherein the training queries associated with the training travel plans associated with the plurality of geographic areas include questions relating to a time to travel between different points-of-interest depicted in the plurality of images of maps associated with the plurality of geographic areas.

5. The computing system of claim 1, wherein the one or more machine-learned models are trained based on training data including the plurality of images of maps associated with the plurality of geographic areas and by training the one or more machine-learned models to recognize and identify points-of-interest depicted in the plurality of images of maps associated with the plurality of geographic areas.

6. The computing system of claim 1, wherein
the one or more machine-learned models are trained to generate a travel itinerary satisfying a training query associated with a training travel plan associated with the plurality of geographic areas,
the travel itinerary minimizes a travel time between different points-of-interest forming at least a part of the travel itinerary, and
the different points-of-interest are depicted in at least one of the plurality of images of maps associated with the plurality of geographic areas.

7. The computing system of claim 1, wherein the operations further comprise providing, as another input to the one or more machine-learned models, an image of a map including the geographic area, and
based on the input from the user relating to the query associated with the travel plan associated with the geographic area and the image of the map including the geographic area, implementing the one or more machine-learned models to generate the travel itinerary satisfying the query.

8. The computing system of claim 7, wherein the operations further comprise:
processing, by the one or more machine-learned models, the image of the map including the geographic area to recognize a plurality of map features including one or more points-of-interest, one or more geographic terrain features, or one or more road networks, and
based on the input from the user relating to the query associated with the travel plan associated with the geographic area, the image of the map including the geographic area, and the plurality of map features, implementing the one or more machine-learned models to generate the travel itinerary satisfying the query.

9. The computing system of claim 1, wherein the operations further comprise:
evaluating the travel itinerary to detect a presence of any feasibility errors,
based on results of the evaluating, detecting the presence of at least one feasibility error, implementing the one or more machine-learned models to generate a revised travel itinerary satisfying the query based on the at least one feasibility error, and
providing, as a further output, the revised travel itinerary.

10. The computing system of claim 9, wherein evaluating the travel itinerary to detect the presence of any feasibility errors comprises the one or more machine-learned models calling a map application programming interface to determine whether travel between locations forming part of the travel itinerary is possible or takes less than a threshold duration of time.

11. The computing system of claim 1, wherein the one or more machine-learned models include a generative machine-learned model provided at the computing system.

12. The computing system of claim 11, wherein
the computing system comprises one or more databases configured to store a plurality of generative machine-learned models respectively associated with a plurality of different geographic areas, and
the operations further comprise retrieving, from among the plurality of generative machine-learned models, the generative machine-learned model associated with the geographic area.

13. The computing system of claim 11, wherein
the generative machine-learned model has been fine-tuned based on a large parameter generative machine-learned model having a greater number of parameters than the generative machine-learned model.

14. A computer-implemented method for generating a travel itinerary, comprising:
receiving an input from a user relating to a query associated with a travel plan associated with a geographic area;
based on the input, implementing one or more machine-learned models to generate the travel itinerary satisfying the query, wherein the one or more machine-learned models are trained to generate travel itineraries based on a plurality of images of maps associated with a plurality of geographic areas; and
providing, as an output, the travel itinerary.

15. The computer-implemented method of claim 14, wherein
the input comprises a text query that specifies one or more points-of-interest associated with the geographic area, and
the plurality of images of maps associated with the plurality of geographic areas include the one or more points-of-interest.

16. The computer-implemented method of claim 14, wherein the one or more machine-learned models are trained based on training data including the plurality of images of maps associated with the plurality of geographic areas and by instructing the one or more machine-learned models to respond to training queries associated with training travel plans associated with the plurality of geographic areas by selecting correct answers from among a plurality of answers, the plurality of answers including more than one correct answer and at least one incorrect answer.

17. The computer-implemented method of claim 14, wherein the one or more machine-learned models are trained based on training data including the plurality of images of maps associated with the plurality of geographic areas and by training the one or more machine-learned models to recognize and identify points-of-interest depicted in the plurality of images of maps associated with the plurality of geographic areas.

18. The computer-implemented method of claim 14, further comprising:
providing, as another input to the one or more machine-learned models, an image of a map including the geographic area, and
implementing the one or more machine-learned models to generate the travel itinerary satisfying the query is based on the input from the user relating to the query associated with the travel plan associated with the geographic area and the image of the map including the geographic area.

19. The computer-implemented method of claim 14, further comprising:
evaluating the travel itinerary to detect a presence of any feasibility errors;
based on results of the evaluating, detecting the presence of at least one feasibility error, implementing the one or more machine-learned models to generate a revised travel itinerary satisfying the query based on the at least one feasibility error; and
providing, as a further output, the revised travel itinerary.

20. A non-transitory computer readable medium storing instructions which, when executed by a processor, cause the processor to perform operations for generating a travel itinerary, the operations comprising:
receiving an input from a user relating to a query associated with a travel plan associated with a geographic area;
based on the input, implementing one or more machine-learned models to generate the travel itinerary satisfying the query, wherein the one or more machine-learned models are trained to generate travel itineraries based on a plurality of images of maps associated with a plurality of geographic areas; and
providing, as an output, the travel itinerary.
